(19) United States
(12) Patent Application Publication
(10) Pub. No.: US 2017/0317896 A1
(43) Pub. Date: Nov. 2, 2017

(54) DYNAMIC INTERNET SERVICE PLATFORM SERVICES

(71) Applicant: Verizon Patent and Licensing Inc., Arlington, VA (US)

(72) Inventors: Gong Zhang, Waltham, MA (US); Jian Huang, Sudbury, MA (US)

(21) Appl. No.: 15/139,964

(22) Filed: Apr. 27, 2016

(51) Int. Cl. H04L 12/24

(52) U.S. Cl. CPC H04L 41/5029; H04L 41/508; H04L 41/0293; H04L 41/5009; H04L 41/5032

(57) ABSTRACT

A method, a device, and a non-transitory storage medium that stores instructions to store program data that includes a uniform resource identifier that is hosted by a content provider device; monitor packets transmitted from end devices to the content provider device; determine whether the packets include the uniform resource identifier; store a value that indicates a number of times the uniform resource identifier was included in the packets; generate a report that includes the value; transmit the report to a network device; determine whether the value satisfies a threshold value; receive a request that indicates to activate a toll-free data service for a content hosted by the content provider device based on a determination that the value satisfied the threshold value; and provide the content to end devices based on the activated toll-free data service.

### BACKGROUND

An Internet Service Provider (ISP) or other entity may offer content, such as movies, to mobile users and/or web users in which data usage is not allocated to the users. For example, a content provider may promote a toll-free data program to attract users to particular content.

### BRIEF DESCRIPTION OF THE DRAWINGS

FIG. 1 is a diagram illustrating an exemplary environment in which an exemplary embodiment of a dynamic toll-free data service may be implemented;

FIG. 2A is a diagram illustrating exemplary elements of an exemplary embodiment of the data service platform depicted in FIG. 1;

FIG. 2B is a diagram illustrating exemplary elements of an exemplary embodiment of program portal depicted in FIG. 1;

FIG. 3A is a diagram illustrating exemplary program data stored in a table of the data service platform depicted in FIG. 1;

FIG. 3B is a diagram illustrating exemplary program data stored in a table of the program portal depicted in FIG. 1;

FIG. 4 is a diagram illustrating an exemplary process of the dynamic toll-free data service performed in the exemplary environment depicted in FIG. 1;

FIG. 5 is a diagram illustrating exemplary components of a device that may correspond to one or more of the devices illustrated depicted in FIG. 1;

FIG. 6 is a flow diagram illustrating an exemplary process of the dynamic toll-free data service performed by the data service platform;

FIG. 7 is a flow diagram illustrating an exemplary process of the dynamic toll-free data service performed by the program portal;

FIG. 8 is a diagram illustrating an exemplary environment in which another exemplary embodiment of the dynamic toll-free data service may be implemented;

FIG. 9 is a diagram illustrating exemplary elements of an exemplary embodiment of the end device depicted in FIG. 8;

FIG. 10 is a diagram illustrating an exemplary process of the dynamic toll-free data service performed in the exemplary environment depicted in FIG. 8;

FIG. 11 is a flow diagram illustrating an exemplary process of the dynamic toll-free data service performed by the end device;

FIG. 12 is a diagram illustrating an exemplary environment in which an exemplary embodiment of the program service may be implemented;

FIG. 13 is a diagram illustrating exemplary elements of an exemplary embodiment of the program portal depicted in FIG. 12;

FIG. 14 is a diagram illustrating exemplary program data stored in a table of the program portal depicted in FIG. 12;

FIG. 15 is a diagram illustrating an exemplary contest;

FIG. 16 is a diagram illustrating an exemplary program of a toll-free data service;

FIG. 17 is a diagram illustrating an exemplary process of the program service performed in the exemplary environment depicted in FIG. 12; and

FIGS. 18A and 18B are flow diagrams illustrating an exemplary process of the program service performed by the program portal.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

The development and expansion of toll-free data services for mobile and web users continue. Third party developers may use an ISP software development kit (SDK) or other technologies (e.g., a Representational State Transfer (REST) application programming interface (API)) offered by the ISP to configure a toll-free data service. However, the SDK or the REST API may present to third party developers certain limitations. For example, the SDK may allow the third party developer to develop a client mobile application, but the client mobile application may be configured to allow only predefined content to be free of data usage charges and not allow content and associated data usage charge status (e.g., free versus not free) to change dynamically based on configurable criteria.

According to an exemplary embodiment, a dynamic toll-free data service is described. According to an exemplary embodiment, a data service platform monitors traffic from users to a content provider device. Based on the monitoring of traffic, the data service platform generates reports indicative of the traffic and sends the reports to a program portal. The program portal analyzes the reports to determine whether a threshold has been met that would permit a toll-free data service to be invoked. For example, the program portal stores program data that indicate the parameters of the threshold to be met (e.g. minimum number of views of a content, minimum number of searches for the content to which the threshold pertains, etc.) as well as parameters pertaining to the toll-free data service (e.g., how long the toll-free data service lasts once activated, the name of the content provider, etc.). When the program portal determines that the threshold has been met, the toll-free data service is invoked. For example, the program portal instructs the data service platform that the toll-free data service is invoked for a particular content. The program portal may instruct other network elements that the toll-free data service is invoked so that data usage is not allocated to users. Thereafter, users that obtain the content (e.g., via streaming or downloading) during the time that the toll-free data service is active, the users will not be charged. Rather, the content provider or a sponsor of the toll-free data program will be charged. As an example of the dynamic toll-free data service, a movie that is posted by a content provider that attracts a certain number of clicks can be dynamically set to be viewed by users under a toll-free data service.

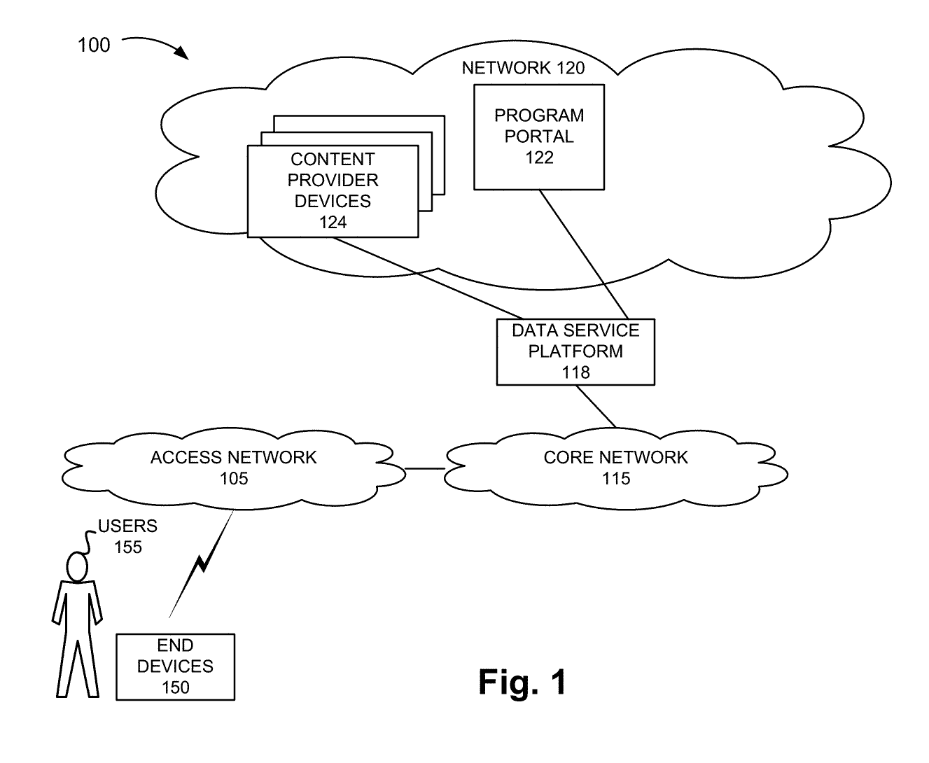

FIG. 1 is a diagram illustrating an exemplary environment 100 in which an exemplary embodiment of a dynamic toll-free data service may be implemented. As illustrated, environment 100 includes an access network 105, a core network 115, a data service platform 118, and a network 120. As illustrated, network 120 includes a program portal 122 and content provider devices 124. Environment 100 further includes end devices 150 and users 155.

Environment 100 includes communicative links between the networks, network devices, and end device 150 and access network 105. Environment 100 may be implemented to include wireless and wired (e.g., electrical, optical, etc.) links. A communicative connection via a communicative link may be direct or indirect. For example, an indirect communicative connection may involve an intermediary device and/or an intermediary network not illustrated in FIG. 1. Additionally, the number and the arrangement of links illustrated in environment 100 are exemplary.

A network device may be implemented according to a centralized computing architecture, a distributed computing architecture, or a cloud computing architecture (e.g., an elastic cloud, a private cloud, a public cloud, etc.). Additionally, a network device may be implemented according to one or multiple network architectures (e.g., a client device, a server device, a peer device, a proxy device, and/or a cloud device). The number of network devices, the number of end devices, the number of networks, and the arrangement in environment 100 are exemplary. For example, although a single data service platform 118 is depicted in FIG. 1, multiple data service platforms 118 may be used to provide the dynamic toll-data free service.

Access network 105 includes one or multiple networks of one or multiple types. For example, access network 105 may be implemented to include a terrestrial network and/or a satellite network. According to an exemplary implementation, access network 105 includes a radio access network (RAN). For example, the RAN may be a Third Generation (3G) RAN, a 3.5G RAN, a Fourth Generation (4G) RAN, a 4.5G RAN, or a future generation RAN (e.g., a Fifth Generation (5G) RAN). By way of further example, access network 105 may include an Evolved UMTS Terrestrial Radio Access Network (E-UTRAN) of a Long Term Evolution (LTE) network or LTE-Advanced (LTE-A) network, a U-TRAN, a Universal Mobile Telecommunications System (UMTS) RAN, a Global System for Mobile Communications (GSM) RAN, a Code Division Multiple Access (CDMA) RAN, a Wideband CDMA (WCDMA) RAN, an Ultra Mobile Broadband (UMB) RAN, a High-Speed Packet Access (HSPA) RAN, an Evolution Data Optimized (EV-DO) RAN, or the like (e.g., a public land mobile network (PLMN), etc.). Access network 105 may also include other types of networks, such as a WiFi network, a local area network (LAN), a personal area network (PAN), or other type of network that provides access to or can be used as an on-ramp to network 120.

Core network 115 includes one or multiple networks of one or multiple types. For example, core network 115 may be implemented to include a terrestrial network and/or a satellite network. According to an exemplary implementation, core network 115 includes a complimentary network pertaining to the one or multiple RANs described. For example, core network 115 may include the core part of an LTE network, an LTE-A network, a CDMA network, a GSM network, and so forth. Depending on the implementation, core network 115 may include various network elements, such as a gateway, a support node, a serving node, a mobility management entity (MME), a router, a switch, a bridge, as well other network elements pertaining to various network-related functions, such as billing, security, authentication and authorization, network polices, subscriber profiles, etc.

Data service platform 118 includes a network device that provides a dynamic toll-free data service. Data service platform 118 includes logic that analyzes traffic that is received from end devices 150 and is directed to content provider devices 124. Based on the analysis, data service platform 118 generates a report. The type of analysis and the data included in a report may be configured based on parameters provided by sponsors or content providers to the service provider of the dynamic toll-free data service, which in turn, can be configured on data service platform 118. Data service platform includes logic that transmits reports to program portal 122 in response to the generation of the reports. Data service platform 118 includes logic that enables and disables the dynamic toll-free data service in response to commands from program portal 122.

As illustrated, data service platform 118 may be implemented as an intermediary network device residing between core network 115 and an external network (e.g., network 120). By way of example, in a core network of LTE, data service platform 118 may reside between a packet data network gateway (PGW) (not illustrated) and network 120. According to other exemplary implementations, data service platform 118 may be implemented elsewhere in access network 105 or core network 115, either as a standalone network element or in a network element of the wireless network architecture. For example, in the LTE architecture, data service platform 118 may be implemented in an evolved Node B (eNB) or a PGW. Depending on the administrative configuration, the PGW may be configured to serve certain types of traffic of users 155. For example, the PGW may be used for Internet traffic versus traffic directed to an Internet Protocol Multimedia Subsystem (IMS) or some other type of external network. Data service platform 118 may be implemented on a network computer. Data service platform 118 is further described herein.

Network 120 includes one or multiple networks of one or multiple types. For example, network 120 may include the Internet, the World Wide Web, a wide area network (WAN), a metropolitan area network (MAN), a service provider network, a private IP network, or some other type of network that is external to core network 115.

Program portal 122 includes a network device that provides the dynamic toll-free data service. Program portal 122 includes logic that manages dynamic toll-free data programs. For example, program portal 122 includes logic that governs when a toll-free data service is activated and deactivated for a particular content. For example, based on the reports provided by data service platform 118 and parameters provided by the sponsors or content providers, program portal 122 determines when to enable the toll-free data service and when to disable the toll-free data service. Program portal 122 includes logic that transmits commands to data service platform 118 that inform data service platform 118 when the toll-free data service is enabled and when the toll-free data service is disabled.

Program portal 122 includes logic that stores program data. The program data includes data indicating the parameters of a toll-free data program. The program data may be configured by a content provider or sponsor of the toll-free data program and/or a service provider of the dynamic toll-free data service. Program portal 122 may be implemented on a network computer. Program portal 122 is further described herein.

Content provider devices 124 include network devices that stores or makes available contents for users 155. For example, content provider devices 124 may be implemented as web servers, streaming servers, file servers, origin servers, or the like. Content provider devices 124 may provide a streaming service and/or a downloading service. Content provider devices 124 may be associated with different content providers that provide contents to users as a paid service. The term “content,” as used herein, is intended to be interpreted as audio content, video content, or audio and video content. For example, content may correspond to a movie, a television program, a live program, a pre-recorded program, a documentary, a reality show, a music event, a sporting event, or some other entertainment event. Content may also correspond to a song, a collection of songs, or some other type of music package.

End devices 150 include devices that have computational and wireless communicative capabilities. End devices 150 may be implemented as mobile devices, portable devices, or other types of end user devices. For example, end devices 150 may be implemented as smartphones, personal digital assistants, tablets, netbooks, phablets, infotainment systems in vehicles, wearable devices (e.g., watches, glasses, etc.), computers (e.g., desktops, laptops, palmtops, etc.), or gaming devices. Alternatively, for example, end devices 150 may be implemented as set top boxes, smart televisions, or other types of multimedia devices (e.g., Roku boxes, streaming media sticks, etc.). Each of end devices 150 includes software that enables each user 155 to access and select content from at least one of content provider devices 124. For example, the software may be implemented as a web browser or some other type of application (e.g., a client of the content provider or a third party). The software may also provide a media player that allows user 155 to listen and/or view the content via streaming or subsequent to the downloading of the content. Users 155 are persons that operate end devices 150. Users 155 may subscribe to a content service offered by content providers in which content provider devices 124 makes available the content to users 155.

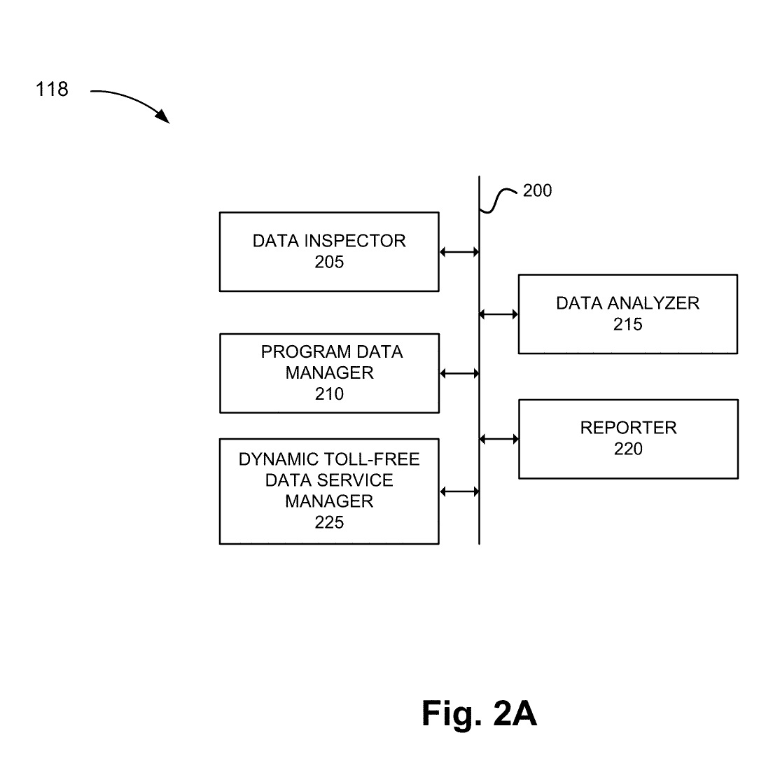

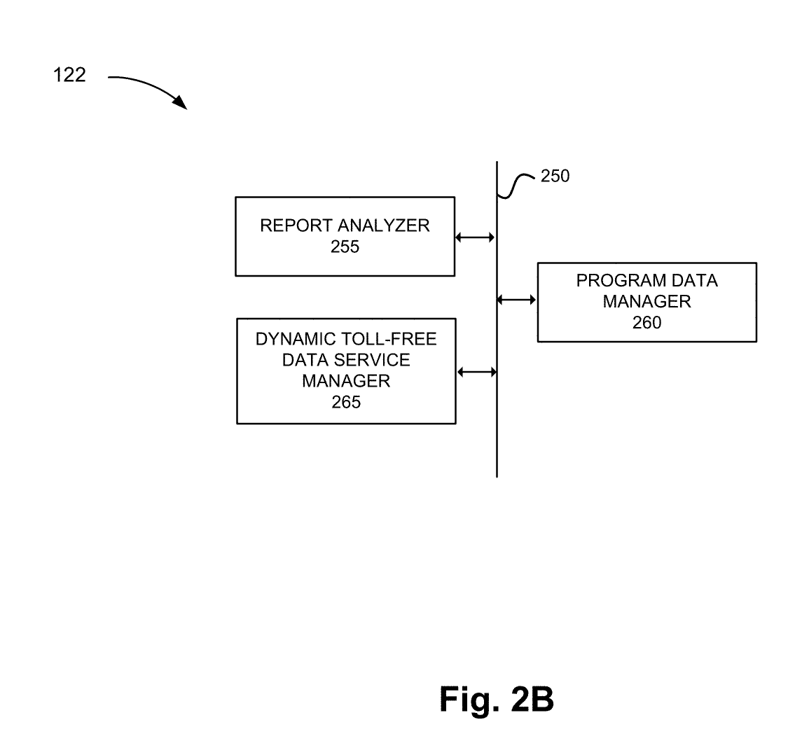

FIG. 2A is a diagram illustrating exemplary elements of an exemplary embodiment of data service platform 118. Referring to FIG. 2A, data service platform 118 includes a data inspector 205, a program data manager 210, a data analyzer 215, a reporter 220, and a dynamic toll-free data service manager 225. According to other exemplary embodiments, data service platform 118 may include additional, fewer, and/or different elements than those illustrated in FIG. 2A and described herein. Additionally, multiple elements may be combined into a single element and/or a single element may be implemented as multiple elements in which a process or a function may be collaboratively performed or multiple processes or functions may be split between them.

Link 200 provides a communicative link between two or more elements. Link 200 may be implemented as a hardware link (e.g., a bus, a shared memory space, etc.) or a software link (e.g., inter-process communication (IPC), etc.). Data inspector 205 includes logic that inspects packets. According to an exemplary implementation, data inspector 202 uses a packet inspection method. For example, data inspector 202 may perform deep packet inspection. As a result of the packet inspection, data inspector 202 obtains network protocol data (e.g., source address, destination address, port number, etc.). According to another exemplary implementation, data inspector 205 uses a packet filtering method. As a result of the packet filtering, data inspector 205 obtains the network protocol data.

Program data manager 210 includes logic that stores and updates program data. According to an exemplary embodiment, program data manager 210 includes a database management system (DBMS). The DBMS may be implemented using conventional, well-known, or commercially available relational or No Structured Query Language (NoSQL) software/packages (e.g., Microsoft SQL, Oracle Database, Cassandra, MongoDB, etc.). Program data manager 210 includes a storage device that stores a database. The database stores program data. According to an exemplary embodiment, the program data includes data indicating uniform resource identifiers (URIs) hosted by content provider devices 124. According to various implementations, the URIs may pertain to various user activities relative to content provider devices 124. For example, when users 155 select a particular content to stream or download, search for a particular content, browse description information pertaining to a particular content, or any other user activity that may occur, such user activities may be associated with URIs hosted by content provider device 124. In this regard, a content provider or other entity may configure particular user activities and/or URIs as criteria to invoke a toll-free data service. The database may store the program data in various types of data structures, an example of which is described below.

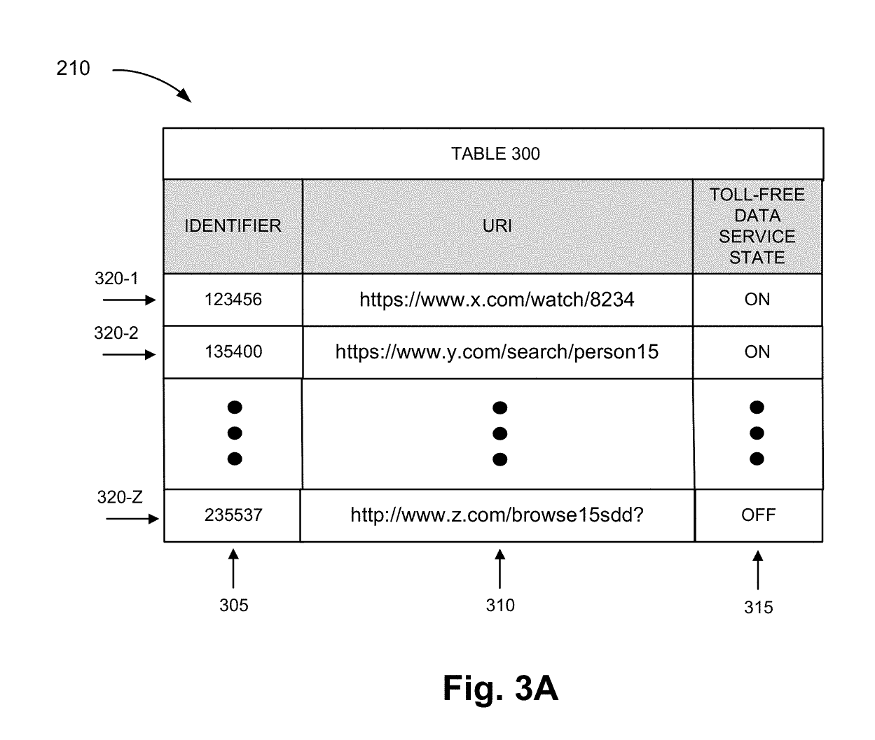

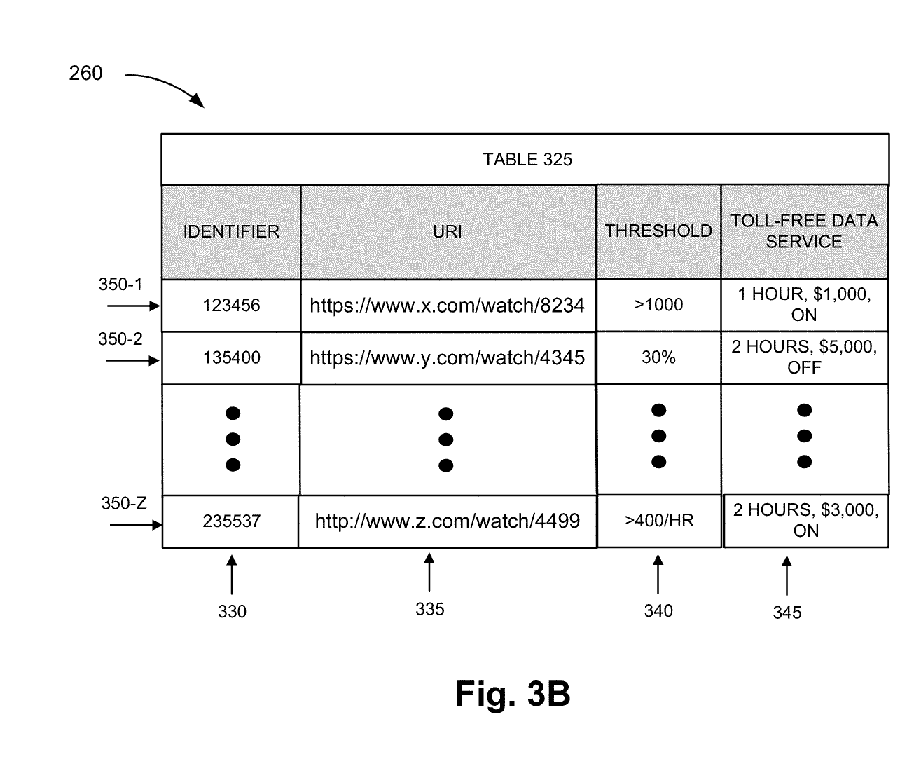

FIG. 3A is a diagram that illustrates exemplary types of program data that may be stored in a table 300. As illustrated, table 300 includes an identifier field 305, a URI field 310, and a toll-free data service state field 315. As further illustrated, table 300 includes profiles 320-1 through 320-Z (also referred to as profiles 320 and, individually and generically as profile 320). Each profile 320 includes a grouping of data fields 305 through 315. Each profile 320 includes at least one instance of program data that is different from another profile 320.

Identifier field 305 stores one or multiple unique identifiers. For example, identifier field 305 may store an entity identifier that identifies a content provider and/or a sponsor of the toll-free data service for a particular content and/or toll-free data program. Identifier field 305 may store a program identifier that identifies a particular toll-free data program that is associated with a URI/content offered under a toll-free data service. URI field 310 stores a unique URI. The URI is a URI hosted by one of content provider devices 124. Toll-free data service state field 315 stores data indicating whether a toll-free data service is enabled or disabled pertaining to profile 320. Toll-free data service state field 315 is described further below.

According to other implementations, table 300 may store additional instances of program data, fewer instances of program data, and/or different types of program data. For example, according to other exemplary implementations, table 300 may not include identifier field 305 and/or toll-free data service state field 315.

Referring back to FIG. 2A, data analyzer 215 includes logic that compares URIs provided by data inspector 205 to URI field 310 of table 300. That is, the URIs may correspond to destination addresses obtained by data inspector 205. According to an exemplary implementation, when data analyzer 215 determines that there is a match between a URI included in an inspected packet and table 300, data analyzer 215 determines whether the URI should be included in a report. For example, referring back to FIG. 3A, when toll-free data service state field 315 indicates that the toll-free data service is not enabled, data analyzer 215 determines that the URI should be included in the report. However, when toll-free data service state field 315 indicates that the toll-free data service is enabled, data analyzer 215 determines that the URI should not be included in the report. According to other exemplary implementations, this determination may not be performed. For example, during the enablement of the toll-free data service, traffic may be continuously monitored. By way of example, the toll-free data program may be configured that when a threshold is met during the enablement of the toll-free data service, the time and/or the budget of the toll-free data service is extended. Conversely, when the threshold is not met during the enablement of the toll-free data service, the time and/or the budget of the toll-free data service may be shortened.

The toll-free data service may be configured to apply to a URI hosted by one of content provider devices 124. For example, content hosted by one of content provider devices 124, which is at a location indicated by the URI, may be the URI that users 155 navigate to or are directed to in order to stream or download the content. As described herein, however, the URI indicated in URI field 310 may or may not be a different URI than the URI of the toll-free data service. That is, as previously described, the URI stored in URI field 310 indicates a URI that serves as a criteria that can be used to measure whether a threshold has been met. For example, the URI indicated in URI field 310 may indicate a URI associated with a user search, whereas the URI of the toll-free data service may be a URI that allows users 155 to watch a particular movie. In this regard, when toll-free data service state field 315 indicates that the toll-free data service is enabled (e.g., “ON”) or disabled (e.g., “OFF), as illustrated in field 315 of table 300, the URI stored in field 310 may or may not store the URI of the toll-free data service.

Reporter 220 includes logic that generates a report that indicates a status of the traffic monitored, inspected, and analyzed in relation to the program data. According to an exemplary implementation, reporter 220 or data analyzer 215 may include logic that counts the number of times a particular URI during a particular period of time (e.g., every 30 minutes, every hour, etc.) or since the last report has been requested. According to such an implementation, the report may detail the number of times a particular URI indicated in URI field 310 has been requested. The report may also include an identifier of identifier field 305 corresponding to the URI included in profile 320. According to other exemplary implementations, program portal 122 includes logic that provides this counting analysis of the program data to determine whether to enable or disable a toll-free data service associated with a toll-free data program. Reporter 220 includes logic that transmits the report to program portal 122.

Dynamic toll-free data service manager 225 includes logic that enables and disables the dynamic toll-free data service in relation to a particular program of a toll-free data service. For example, dynamic toll-free data service manager 225 includes logic that receives a command from program portal 122 indicating that the dynamic toll-free data service is to be enabled, and receives a command from program portal 122 indicating that the dynamic toll-free data service is to be disabled. Based on the commands, program data manager 210 may correspondingly update toll-free data service state field 315.

Dynamic toll-free data service manager 225 may also perform other processes in response to the updating. For example, dynamic toll-free data service manager 225 may generate a charging data record (CDR) or a data usage record (DUR) that pertains to traffic associated with the toll-free data service. For example, traffic that is monitored and analyzed by data inspector 205 and data analyzer 215 identify packets or a flows (e.g., streaming, downloading) that include or are associated with the URL of the toll-free data service. Dynamic toll-free data service manager 225 may generate CDRs or DURs based on the identified packets or flows. For example, a CDR or a DUR may include an end user identifier, a program identifier, and/or a content provider identifier and, a data usage amount and a time stamp (e.g., a date and time).

According to another example, in response to receiving the command from program portal 122 and updating toll-free data service state field 315, dynamic toll-free data service manager 225 may generate and transmit a message to another network device. For example, in an LTE network, dynamic toll-free data service manager 225 may generate and transmit a message that instructs the PGW that the toll-free data service is active for a particular URL and for CDRs to be generated accordingly. The PGW may then generate a CDR that accounts for data usage associated with user 155 during the toll-free data service. The CDRs may be processed by other network devices (e.g., an online charging system (OCS), an Offline Charging System (OFCS), etc.). Additionally, in response to receiving a command from program portal 122 that the toll-free data service is deactivated, dynamic toll-free data service manager 225 may stop generating CDRs or DURs for that toll-free data service. Alternatively, dynamic toll-free data service manager 225 may generate and transmit a message that instructs the PGW that the toll-free data service is no longer active, and the PGW and other billing systems would account for the data usage and charges accordingly.

Also, according to an exemplary implementation, as previously described, when toll-free service state field 315 is updated to indicate that the toll-free data service is activated, data service platform 118 may continuously monitor and analyze packets, generate reports, etc., which may result in the toll-free data service being extended or shortened.

FIG. 2B is a diagram illustrating exemplary elements of an exemplary embodiment of program portal 122. Referring to FIG. 2B, program portal 122 includes a report analyzer 255, a program data manager 260, and a dynamic toll-free data service manager 265. According to other exemplary embodiments, program portal 122 may include additional, fewer, and/or different elements than those illustrated in FIG. 2B and described herein. Additionally, multiple elements may be combined into a single element and/or a single element may be implemented as multiple elements in which a process or a function may be collaboratively performed or multiple processes or functions may be split between them.

Link 250 provides a communicative link between two or more elements. Link 250 may be implemented as a hardware link (e.g., a bus, a shared memory space, etc.) or a software link (e.g., inter-process communication (IPC), etc.). Report analyzer 255 includes logic that analyzes reports received from data service platform 118. Based on the analysis, report analyzer 255 determines whether a threshold of a toll-free data program has been met that would enable a toll-free data service to be invoked. Report analyzer 255 uses program data stored by program data manager 260 to determine whether or not the threshold has been met.

Program data manager 260 includes logic that stores and updates program data. According to an exemplary embodiment, program data manager 260 includes a DBMS. The DBMS may be implemented using conventional, well-known, or commercially available relational or NoSQL software/packages (e.g., Microsoft SQL, Oracle Database, Cassandra, MongoDB, etc.). Program data manager 260 includes a storage device that stores a database. The database stores program data. According to an exemplary embodiment, the program data includes data indicating parameters indicating the threshold. According to an exemplary embodiment, the program data includes data indicating parameters pertaining to the toll-free data service. Program data manager 260 includes logic that provides an interface to a user (e.g., an administrator) to configure, update, delete, etc. a toll-free data program. For example, content providers and/or sponsors of the program may configure the toll-free data program by way of storing program data via program data manager 260. The database may store the program data in various types of data structures, an example of which is described below.

FIG. 3B is a diagram that illustrates exemplary types of program data that may be stored in a table 325. As illustrated, table 325 includes an identifier field 330, a URI field 335, a threshold field 340, and a toll-free data service field 345. As further illustrated, table 325 includes profiles 350-1 through 350-Z (also referred to as profiles 350 and, individually and generically as profile 350). Each profile 350 includes a grouping of data fields 330 through 345. Each profile 350 includes at least one instance of program data that is different from another profile 350.

Identifier field 330 stores one or multiple unique identifiers. For example, identifier field 330 may store an entity identifier that identifies a content provider and/or a sponsor of the toll-free data service for a particular content and/or toll-free data program. Identifier field 330 may store a program identifier that identifies a particular toll-free data program that is associated with a URI/content offered under a toll-free data service. URI field 335 stores a unique URI. The URI is a URI hosted by one of content provider devices 124. For example, the URI may be the location of content available when the toll-free data service is activated.

Threshold field 340 stores data that indicates a threshold that is to be met to activate the toll-free data service. For example, the data may indicate a certain number of requests of a particular URI to occur, a certain percentage of requests of a particular URI relative to other URI(s) to occur, or some other criteria based on requests to URIs to occur before a toll-free data service is activated. The data may indicate a particular request (e.g., a particular URI) that is to be applied to the certain number. The data may also indicate a time factor. For example, the certain number of requests must occur within a certain period of time. While the thresholds described are exemplary, the threshold may be configured to a desired condition or parameter. Thus, referring back to FIG. 2B, report analyzer 255 may compare data included in the report with data stored in threshold field 340 to determine whether a threshold has been met or not. Depending on the data included in the report and the data included in table 325, report analyzer 255 may perform other types of functions such as counting URIs included in the report, correlating the URIs included in the report to a program identifier, a content provider identifier, etc., as such URIs and/or other types of data pertain to a particular toll-free data program.

Referring back to FIG. 3B, toll-free data service field 345 stores data that indicates parameters pertaining to the toll-free data service of a toll-free data program. For example, toll-free data service field 345 may store various types of data, such as data indicating when the toll-free data service begins (e.g., a date, a time, etc.), when the toll-free data service ends, a length of time of the toll-free data service (once activated), a length of time of the toll-free data program (e.g., runs for 1 week, 1 day, etc.), a budget associated with the toll-free data service (e.g., $1,000, a data transfer maximum in Megabytes (MBs) or Gigabytes (GBs)), a content associated with the toll-free data service (e.g., a content identifier, etc.), and a state of the toll-free data service (e.g., active, on, off, deactivated, etc.).

According to other implementations, table 325 may store additional instances of program data, fewer instances of program data, and/or different types of program data. For example, according to other exemplary implementations, table 325 may not include identifier field 330 and/or toll-free data service field 345. Additionally, or alternatively, threshold field 340 may store data that indicates thresholds which when met may extend or shorten the length of time of the toll-free data service associated with a toll-free data program. For example, assume that a threshold of greater than 1000 hits triggers the activation of toll-free data service for 2 hours. Threshold field 340 may store another threshold that indicates, for example, if greater than 5000 hits occur during the 2 hours, the toll-free data service will be extended by 30 minutes. Conversely, a threshold that indicates, for example, if less than 200 hits occur during the first hour, the toll-free data service will be shorted by 30 minutes.

Referring to back to FIG. 2B, dynamic toll-free data service manager 265 includes logic that activates toll-free data services associated with toll-free data programs. For example, dynamic toll-free data service manager 265 determines whether to activate a toll-free data service based on a determination made by report analyzer 255 in view of reports received and analyzed. Dynamic toll-free data service manager 265 includes logic that deactivates toll-free data services based on the parameters stored in toll-free data service field 345 of table 325. Dynamic toll-free data service manager 265 may also extend or shorten a toll-free data service based on data stored in threshold field 340 of table 325. When a toll-free data service is activated and deactivated, dynamic toll-free data service manager 265 transmits messages to appropriate network elements including data service platform 118.

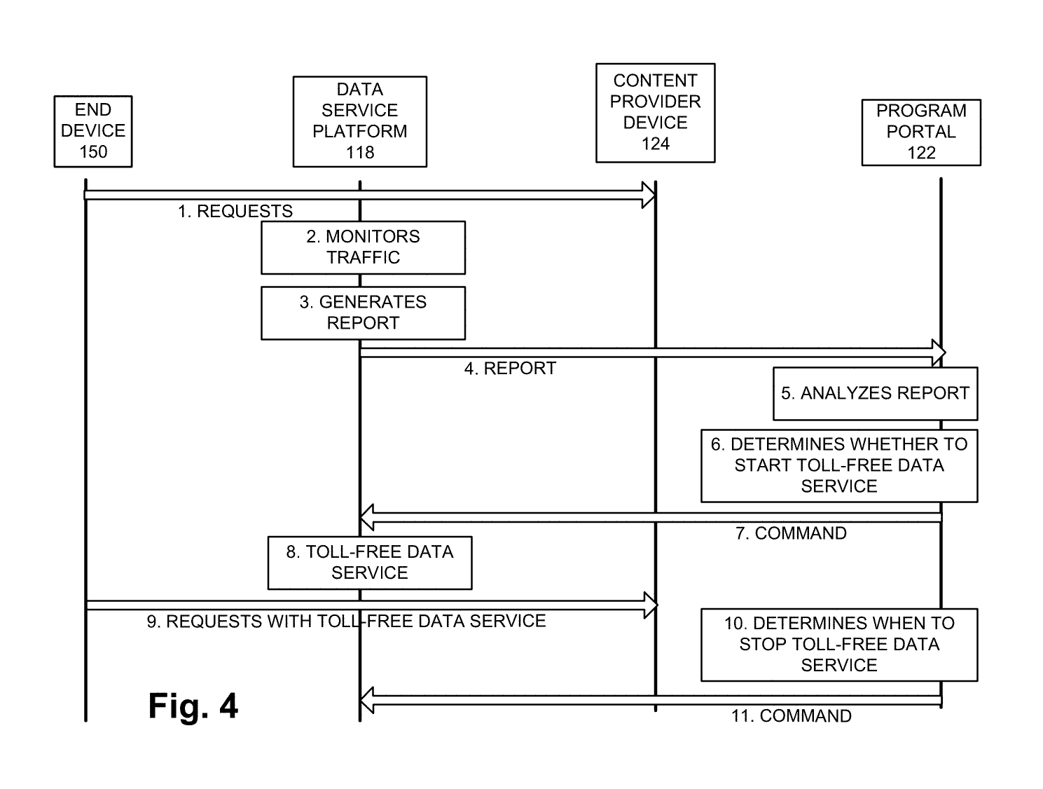

FIG. 4 is a diagram illustrating an exemplary process of the dynamic toll-free data service performed in environment 100. As illustrated in FIG. 4, in step 1, users 155 via end devices 150 communicate with content provider devices 124 via data service platform 118. For example, users 155 may make requests to view content, search content, and so forth. In step 2, in response to the communications, data service platform 118 monitors and analyzes the traffic between end devices 150 and content provider devices 124. In step 3, data service platform 118 generates a report in response to the monitoring and analyzing. In step 4, based on the analysis of the traffic, data service platform 118 transmits a report to program portal 122. The report includes data that can be used to determine whether a threshold for activating a toll-free data service has been met. In step 5, program portal 122 receives and analyzes the report based on program data stored by program portal 122. The analysis may include determining whether a threshold has been met for activating a toll-free data service of a toll-free data program based on the program data and the report. In step 6, based on the analysis, program portal 122 determines whether to activate a toll-free data service of a toll-free data program. In step 7, when a threshold has been met, program portal 122 transmits a command to data service platform 118 indicating that the toll-free data service of the toll-free data program is activated. In step 8, data service platform 118 enables toll-free data service. As illustrated in step 9, requests to stream or download content from end devices 150 to one of content provider devices 124 are supported by the toll-free data service. In step 10, program portal 122 monitors the time period of the toll-free data service, and in step 11, transmits a command to data service platform 118 when it is determined that the toll-free data service period has expired.

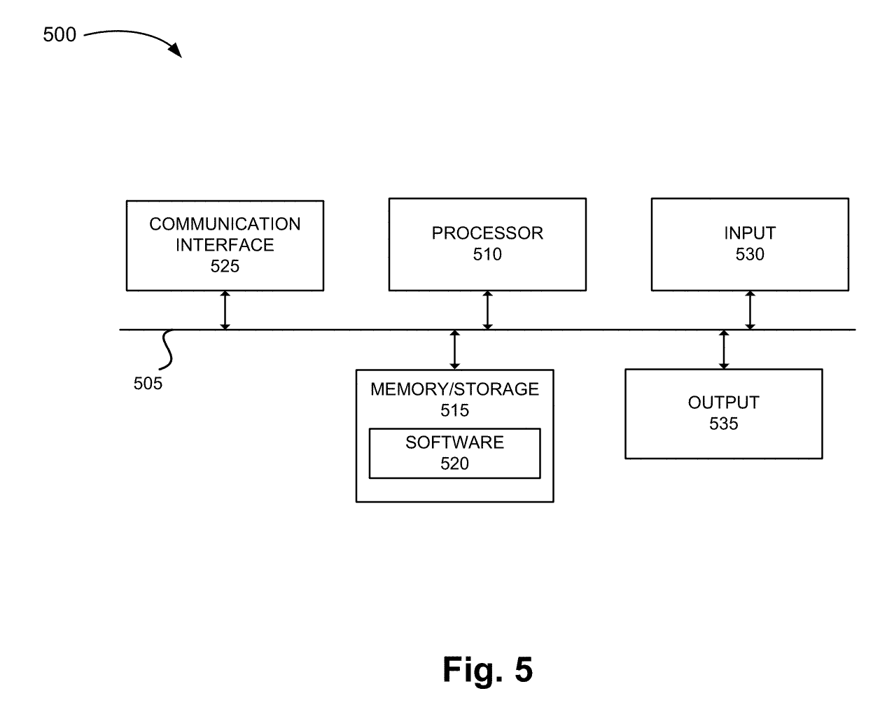

FIG. 5 is a diagram illustrating exemplary components of a device 500 that may correspond to one or more of the devices in environments described herein. For example, device 500 may correspond to data service platform 118, program portal 122, content provider devices 124, end devices 150, and other devices described herein. Additionally, exemplary elements of devices may be implemented based on the components described herein. As illustrated in FIG. 5, device 500 includes a bus 505, a processor 510, memory/storage 515 that stores software 520, a communication interface 525, an input 530, and an output 535. According to other embodiments, device 500 may include fewer components, additional components, different components, and/or a different arrangement of components than those illustrated in FIG. 5 and described herein.

Bus 505 includes a path that permits communication among the components of device 500. For example, bus 505 may include a system bus, an address bus, a data bus, and/or a control bus. Bus 505 may also include bus drivers, bus arbiters, bus interfaces, clocks, and so forth.

Processor 510 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 510 may be implemented as hardware (e.g., a microprocessor, etc.), a combination of hardware and software (e.g., a SoC, an ASIC, etc.), may include one or multiple memories (e.g., cache, etc.), etc.

Processor 510 may control the overall operation or a portion of operation(s) performed by device 500. Processor 510 may perform one or multiple operations based on an operating system and/or various applications or computer programs (e.g., software 520). Processor 510 may access instructions from memory/storage 515, from other components of device 500, and/or from a source external to device 500 (e.g., a network, another device, etc.). Processor 510 may perform an operation and/or a process based on various techniques including, for example, multithreading, parallel processing, pipelining, interleaving, etc.

Memory/storage 515 includes one or multiple memories and/or one or multiple other types of storage mediums. For example, memory/storage 515 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other type of memory. Memory/storage 515 may include a hard disk (e.g., a magnetic disk, an optical disk, a magneto-optic disk, a solid state disk, etc.) and a corresponding drive. Memory/storage 515 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 515 may include drives for reading from and writing to the storage medium.

Memory/storage 515 may be external to and/or removable from device 500, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). Memory/storage 515 may store data, software 520, and/or instructions related to the operation of device 500.

Software 520 includes an application or a program that provides a function and/or a process. Software 520 may also include firmware, middleware, microcode, hardware description language (HDL), and/or other form of instruction. As an example, with reference to data service platform 118, software 520 may include an application that, when executed by processor 510, provides the functions of the dynamic toll-free data service, as described herein. Additionally, with reference to program portal 122, software 520 may include an application that, when executed by processor 510, provides the functions of the dynamic toll-free data service.

Communication interface 525 permits device 500 to communicate with other devices, networks, systems, and/or the like. Communication interface 525 includes one or multiple wireless interfaces. For example, communication interface 525 may include one or multiple transmitters and receivers, or transceivers. Communication interface 525 may operate according to a protocol stack and a communication standard. Communication interface 525 may include an antenna. Communication interface 525 may include various processing logic or circuitry (e.g., multiplexing/de-multiplexing, filtering, amplifying, converting, error correction, etc.).

Input 530 permits an input into device 500. For example, input 530 may include a keyboard, a mouse, a display, a button, a switch, an input port, speech recognition logic, a microphone, a camera, and/or some other type of visual, auditory, tactile, etc., input component. Output 535 permits an output from device 500. For example, output 535 may include a speaker, a display, a light, an output port, and/or some other type of visual, auditory, tactile, etc., output component. According to some embodiments, input 530 and/or output 535 may be a device that is attachable to and removable from device 500.

Device 500 may perform a process and/or a function, as described herein, in response to processor 510 executing software 520 stored by memory/storage 515. By way of example, instructions may be read into memory/storage 515 from another memory/storage 515 (not shown) or read from another device (not shown) via communication interface 525. The instructions stored by memory/storage 515 cause processor 510 to perform a process described herein. Alternatively, for example, according to other implementations, device 500 performs a process described herein based on the execution of hardware (processor 510, etc.).

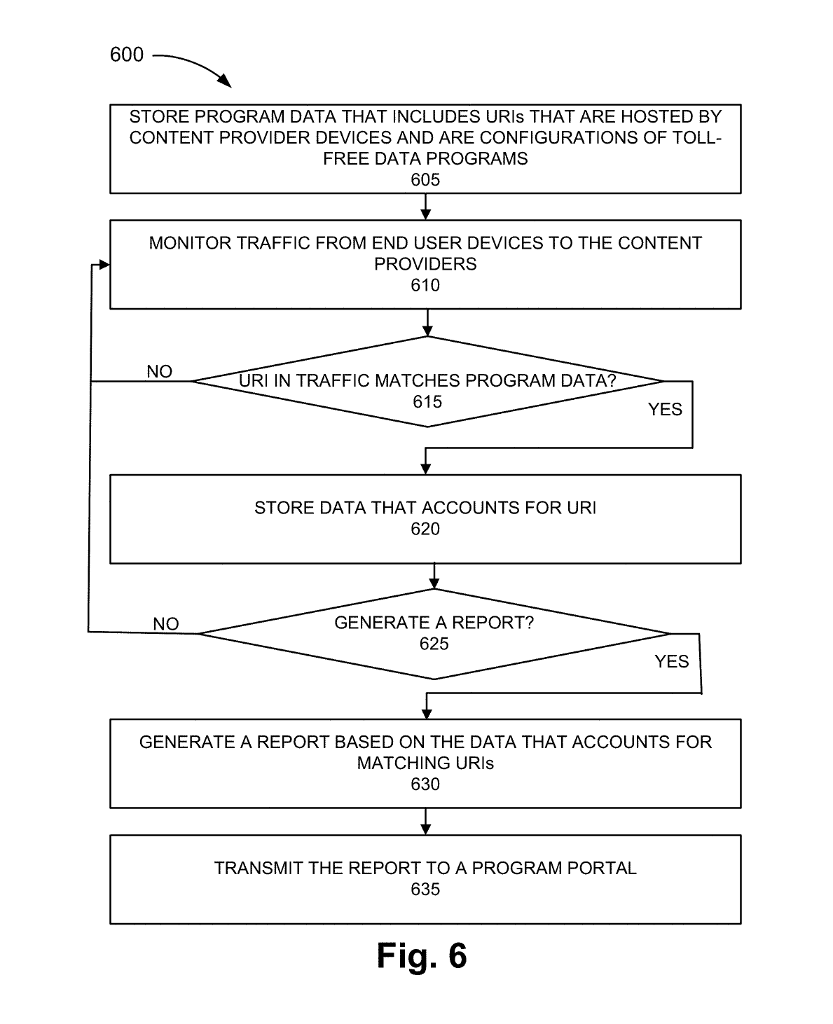

FIG. 6 is a flow diagram illustrating an exemplary process 600 pertaining to the dynamic toll-free data service. Process 600 is directed to a process described with respect to FIGS. 2A, 2B, and 4, as well as elsewhere in this description, in which data service platform 118 provides a dynamic toll-free data service. For example, processor 510 executes software 520 to perform the steps illustrated in FIG. 6 and described.

Referring to FIG. 6, process 600 may begin, in block 605, with storing program data that includes URIs that are hosted by content provider devices and are configurations of toll-free data programs. For example, data service platform 118 stores program data. The program data includes URIs of content provider devices 124 that are used as bases to determine when toll-free data services are activated. The URIs may be configured by content providers and/or sponsors of the toll-free data programs via program portal 122 and subsequently stored at data service platform 118. As an example, the program data may be stored as the program data of table 300.

In block 610, traffic from end devices to the content providers are monitored. For example, data service platform 118 monitors packets from end devices 150 destined to content provider devices 124. By way of further example, data inspector 205 inspects Transport Control Protocol (TCP) header fields of the packets for Hypertext Transfer Protocol (HTTP) uniform resource locators (URLs).

In block 615, it is determined whether a URI included in the traffic matches the program data. For example, data service platform 118 analyzes a packet based on the inspection to determine whether a URL included in the packet matches any URLs included in the program data. By way of further example, data analyzer 215 analyzes the URL carried in the packet and determines whether the URL matches any of the URLs included in table 300.

When it is determined that the URI does not match the program data (block 615-NO), process continues to block 610. For example, data service platform 118 continues to monitor the traffic from end devices 150.

When it is determined that the URI does match the program data (block 615-YES), data is stored that accounts for the URI (block 620). For example, data service platform 118 may count the number of requests that match the URLs of a particular toll-free data program. By way of further example, data analyzer 215 may use identifier field 305 to aggregate URLs that match URLs of a particular content provider and/or a particular toll-free data program. Data analyzer 215 may store data indicating such a matching. For example, data analyzer 215 may store a numerical value representing the number of URLs included in the traffic that match URLs associated with the content provider and/or the toll-free data program.

In block 625, it is determined whether a report is to be generated. For example, data service platform 118 determines whether to generate a report in response to storing the data. By way of further example, reporter 220 may determine whether to generate a report based on a configurable criteria, such as whether a particular time period has lapsed since the last report has been sent (e.g., for this particular content provider, for this particular toll-free data program, etc.), whether a minimum number of matching URLs has occurred, or any other criteria.

When it is determined that a report is not to be generated (block 625-NO), process 600 continues to block 610. For example, data service platform 118 continues to monitor the traffic. When it is determined that a report is to be generated (block 625-YES), a report is generated based on the data that accounts for the matching URIs (block 630). For example, data service platform 118 generates a report that indicates the number of URLs that matched a particular toll-free data program. The report may also include one or multiple identifiers (e.g., of identifier field 305). By way of further example, reporter 220 may generate the report. In block 635, the report is transmitted to a program portal. For example, reporter 220 of data service platform 118 transmits the report to program portal 122 in response to the generation of the report.

Although FIG. 6 illustrates an exemplary process 600 of the dynamic toll-free data service, according to other embodiments, process 600 may include additional operations, fewer operations, and/or different operations than those illustrated in FIG. 6 and described herein. For example, subsequent to block 615-YES, data service platform 118 may determine whether the toll-free data service is active or not. Data service platform 118 may determine whether the toll-free data service, which is associated with the matching URI, is active or not based on the data stored in toll-free data service state field 315. When the toll-free data service is active, data service platform 118 may not store data that accounts for the matching URI (i.e., in contrast to block 620) since the toll-free data service is active and the threshold has been met. Process 600 may continue to block 610. Alternatively, data service platform 118 may store data that accounts for the matching URI and generate a different type of report that can be used by program portal 122 to determine whether to extend or shorten the active toll-free data service, as previously described. However, when the toll-free data service is not active, process 600 may continue from block 615—YES to block 620, as previously described.

Additionally, as previously described, data service platform 118 may generate CDRs or DURs during the time that the toll-free data service is active since this type of traffic would traverse data service platform 118. Alternatively, data service platform 118 may instruct other network devices (e.g., a PGW, a serving gateway (SGW), etc.) when the toll-free data service is active and when it is not, as well as provide other data (e.g., the URL, a content provider identifier, toll-free data program identifier, etc.) that would allow the network devices to generate CDRs, DURs, etc.

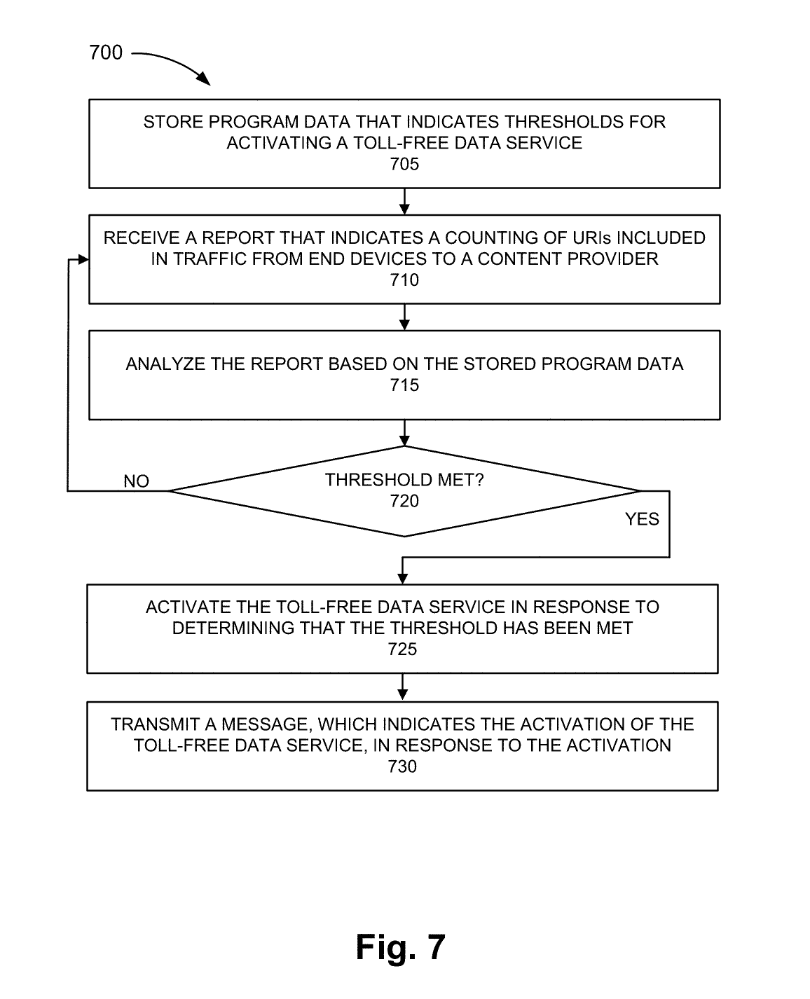

FIG. 7 is a flow diagram illustrating an exemplary process 700 pertaining to the dynamic toll-free data service. Process 700 is directed to a process previously described with respect to FIGS. 2A, 2B, and 4, as well as elsewhere in this description, in which program portal 122 provides the dynamic toll-free data service. For example, processor 510 executes software 520 to perform the steps illustrated in FIG. 7 and described herein.

Referring to FIG. 7, process 700 may begin, in block 705, with storing data that indicates a threshold for activating a toll-free data service. For example, program portal 122 stores program data that indicates a threshold to be met in order to activate a toll-free data service associated with a program. For example, the program data may indicate a certain number of requests (e.g., URLs) that must be received, a certain number of requests that must be received within a certain period of time, or some other type of threshold. As an example, the program data may be stored as the program data of table 325.

In block 705, a report, which indicates a counting of URIs included in traffic from end devices to a content provider, is received. For example, program portal 122 receives a report from data service platform 118. The report may include data, as previously described. By way of further example, report analyzer 255 may receive the report.

In block 715, the report is analyzed based on the stored program data. For example, program portal 122 analyzes the data included in the report to determine whether a threshold has been met. Program portal 122 may compare the data included in the report to the stored program data. By way of further example, report analyzer 255 may analyze the report. The analysis may include comparing numerical values associated with URLs and program identifiers to the program data.

In block 720, it is determined whether a threshold is met based on the analysis. For example, program portal 122 determines whether the number of matching URLs is less than, equal to, or exceeds the threshold values of the program data. Based on the result of the comparison, program portal 122 determines whether the threshold is met. By way of further example, report analyzer 255 determines whether the threshold is met based on the results of a comparison. When it is determined that the threshold has not been met (block 720-NO), process 700 continues to block 710. For example, program portal 122 may wait for a next report to be received.

When it is determined that the threshold has been met (block 720-YES), the toll-free service data service is activated (block 725). For example, in response to determining that a threshold has been met, program portal 122 activates the toll-free data service pertaining to a particular content associated with the program. By way of further example, dynamic toll-free data service manager 265 activates the toll-free data service and the content is dynamically available under such service in accordance with the parameters set forth in toll-free data service field 345 of table 325.

In block 730, a message, which indicates the activation of the toll-free data service, is transmitted to the data service platform in response to the activation. For example, program portal 122 transmits a message to data service platform 118. The message indicates that the toll-free data service has been activated. By way of further example, dynamic toll-free data service manager 265 may generate and transmit the message to data service platform 118. The message may include a URL that is being toll-freed, a content provider identifier, a toll-free data program identifier, and/or a time period of the toll-free data service. As previously described, in response to receiving the message, data service platform 118 updates program data to indicate that the toll-free data service has been activated. Data service platform 118 may perform other functions, as described herein, in response to receiving the message and the data included therein.

Although FIG. 7 illustrates an exemplary process 700 of the dynamic toll-free data service, according to other embodiments, process 700 may include additional operations, fewer operations, and/or different operations than those illustrated in FIG. 7 and described herein.

The embodiments described provide, among other things, a dynamic toll-free data service in which user behavior is captured and reported on the network-side and content is dynamically offered under a toll-free data service based on the analysis of the user behavior. However, according to other exemplary embodiments, user behavior may be captured at the end device. For example, according to another exemplary embodiment of the dynamic toll-free data service, an end user application provides a reporting service. The end user application monitors a user's behavior when connected to a content provider's site that offers content. For example, the end user application monitors which content is being watched, searched for, and/or any other configurable user behavior that may occur on the content provider's site. Based on the monitoring, the end user application generates a report that includes data indicative of the user behavior. The end user application transmits the report to the program portal. In a manner similar to that described above, the program portal analyzes the reports received from end user applications and determines whether a threshold has been met that would permit a toll-free data service to be invoked. When the program portal determines that the threshold has been met, the toll-free data service is invoked. For example, the program portal instructs the data service platform that the toll-free data service is invoked for a particular content.

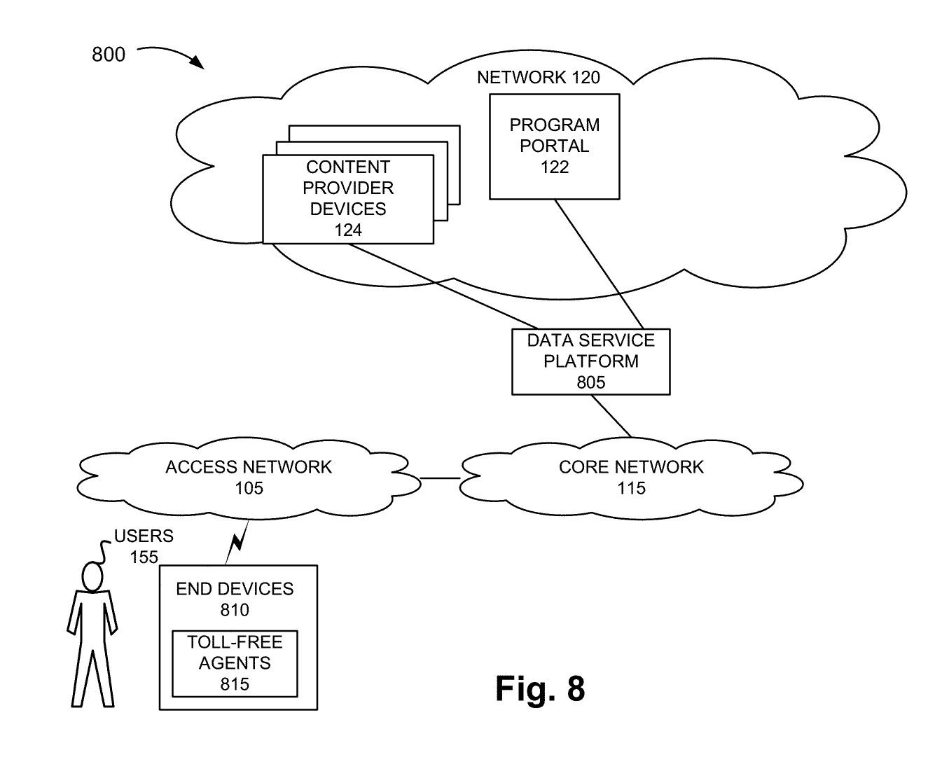

FIG. 8 is a diagram illustrating an exemplary environment in which another exemplary embodiment of a dynamic toll-free data service may be implemented. As illustrated, environment 800 includes access network 105, core network 115, a data service platform 805, and network 120. As illustrated, network 120 includes program portal 122 and content provider devices 124. Environment 800 further includes end devices 810. End devices 810 include toll-free agents 815. Users 155 may operate end devices 810. Access network 105, core network 115, network 120, program portal 122, and content provider devices 124 have been previously described. Data service platform 805 may include dynamic toll-free data service manager 225. However, in view of toll-free agent 815 of end device 810, data service platform 805 may not include other elements (e.g., data inspector 205, data analyzer 215, reporter 220). Additionally, data service platform 805 may include a modification of an element (e.g., program data manager 210). For example, program data manager 210 may store a table that does not include field 310.

Similar to end device 150, end devices 810 include devices that have computational and wireless communicative capabilities. End devices 810 may be implemented as mobile devices, portal devices, or other types of end devices, as previously described. In contrast to end device 150, each of end devices 810 includes toll-free agent 815.

Toll-free agent 815 includes logic that captures user behavior when user 155 visits content provider device 124. For example, toll-free agent 815 monitors and captures URIs of content provider device 124 that is visited by user 155. Toll-free agent 815 generates a report based on the captured data that is stored. Toll-free agent 815 transmits the report to program portal 122.

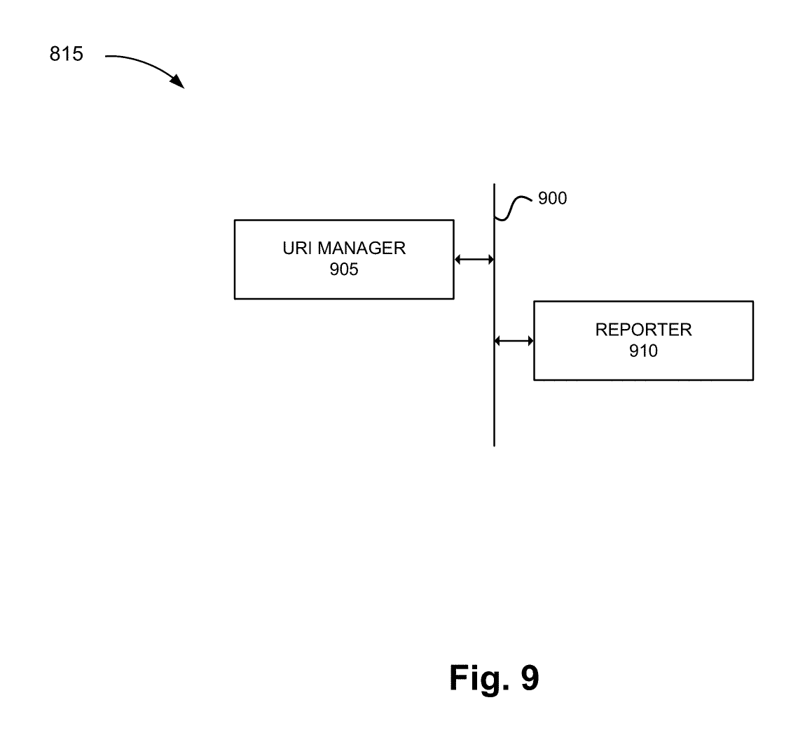

FIG. 9 is a diagram illustrating exemplary elements of an exemplary embodiment of toll-free agent 815. Referring to FIG. 9, toll-free agent 815 includes a URI manager 905 and a reporter 910. According to other exemplary embodiments, toll-free agent 815 may include additional, fewer, and/or different elements than those illustrated in FIG. 9 and described herein. Additionally, multiple elements may be combined into a single element and/or a single element may be implemented as multiple elements in which a process or a function may be collaboratively performed or multiple processes or functions may be split between them.

Link 900 provides a communicative link between two or more elements. Link 900 may be implemented as a hardware link (e.g., a bus, a shared memory space, etc.) or a software link (e.g., inter-process communication (IPC), etc.). URI manager 905 includes logic that identifies URIs of a particular content provider device 124 visited by user 155. According to an exemplary implementation, URI manager 905 may monitor all URLs of content provider device 124 visited and store data indicating the URLs visited. According to other exemplary implementations, URI manager 905 may monitor all URLs of content provider device 124 visited, but store data indicating only particular URLs visited. For example, URI manager 905 may store program data similar to program data stored by program data manager 210, as previously described. However, the program data may pertain to one content provider versus multiple content providers that are different. URI manager 905 may compare the monitored URLs to URLs stored in the program data. URI manager 905 determines when the URLs match based on a result of the comparison. URI manager 905 stores data accounting for the matching URLs visited.

Reporter 910 includes logic that generates a report that indicates traffic, which originated from end device 810 that has been monitored or monitored and analyzed in relation to the program data. According to an exemplary implementation, reporter 910 or URI manager 905 may include logic that counts the number of times a particular URI was requested over a particular period of time or since the last report was generated. According to such an implementation, the report may detail the number of times a particular URI indicated in the program data has been requested. The report may also include an identifier (e.g., an identifier of a toll-free data program, a content provider, a sponsor of the toll-free data service, etc). According to other exemplary implementations, program portal 122 includes logic that performs the counting function and/or performs further analysis of the reporting data to determine whether to enable or disable a toll-free data service associated with a toll-free data program. Reporter 910 includes logic that transmits the report to program portal 122.

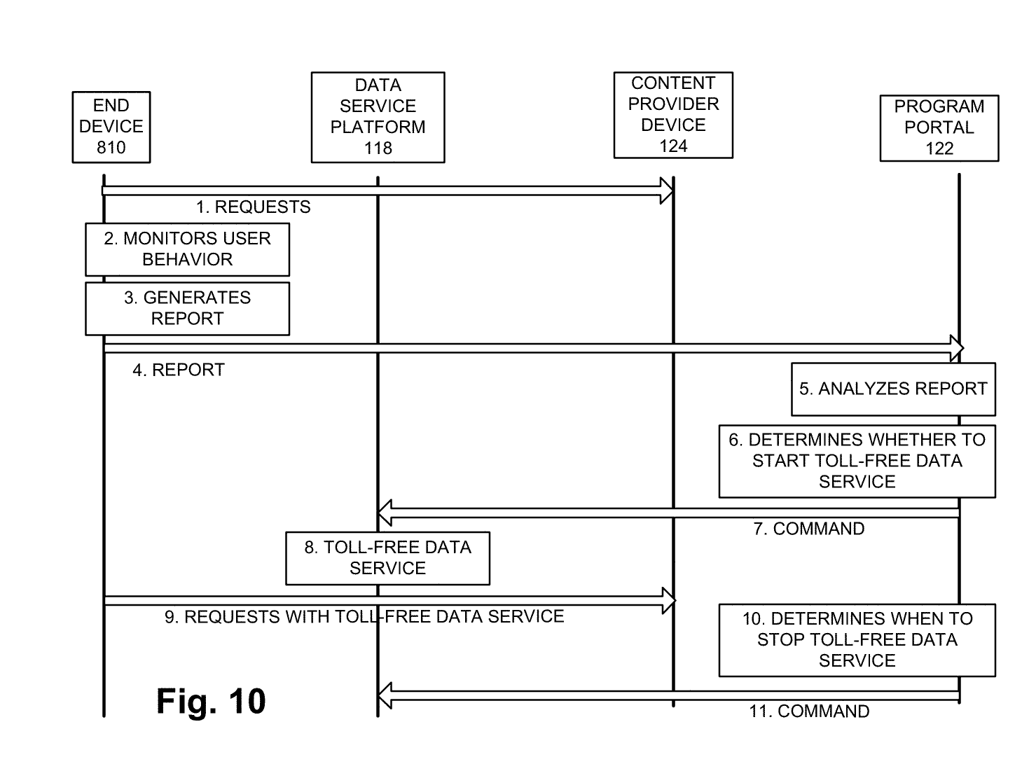

FIG. 10 is a diagram illustrating an exemplary process of the dynamic toll-free data service performed in environment 800. As illustrated in FIG. 10, in step 1, users 155 via end devices 819 communicate with content provider devices 124 via data service platform 805. For example, users 155 may make requests to view content, search content, and so forth. In step 2, in response to the communications, each of end devices 810 monitors (and analyzes) the traffic originating from each end device 810 to one of the content provider devices 124. In steps 3 and 4, based on the monitoring or the monitoring and analysis of the traffic, each of end devices 810 generates and transmits a report to program portal 122. The report includes data that can be used to determine whether a threshold for activating a toll-free data service has been met. In step 5, program portal 122 receives and analyzes the report based on program data stored by program portal 122. The analysis may include determining whether the threshold has been met for activating a toll-free data service of a toll-free data program based on the program data and the report. In step 6, based on the analysis, program portal 122 determines whether to activate a toll-free data service of a toll-free data program. In step 7, when a threshold has been met, program portal 122 transmits a command to data service platform 118 indicating that the toll-free data service of the toll-free data program is activated. In step 8, data service platform 118 enables a toll-free data service. As illustrated in step 9, requests to stream or download content from end devices 810 to one of content provider devices 124 are supported by the toll-free data service. In step 10, program portal 122 monitors the time period of the toll-free data service, and in step 11, transmits a command to data service platform 118 when it is determined that the toll-free data service period has expired.

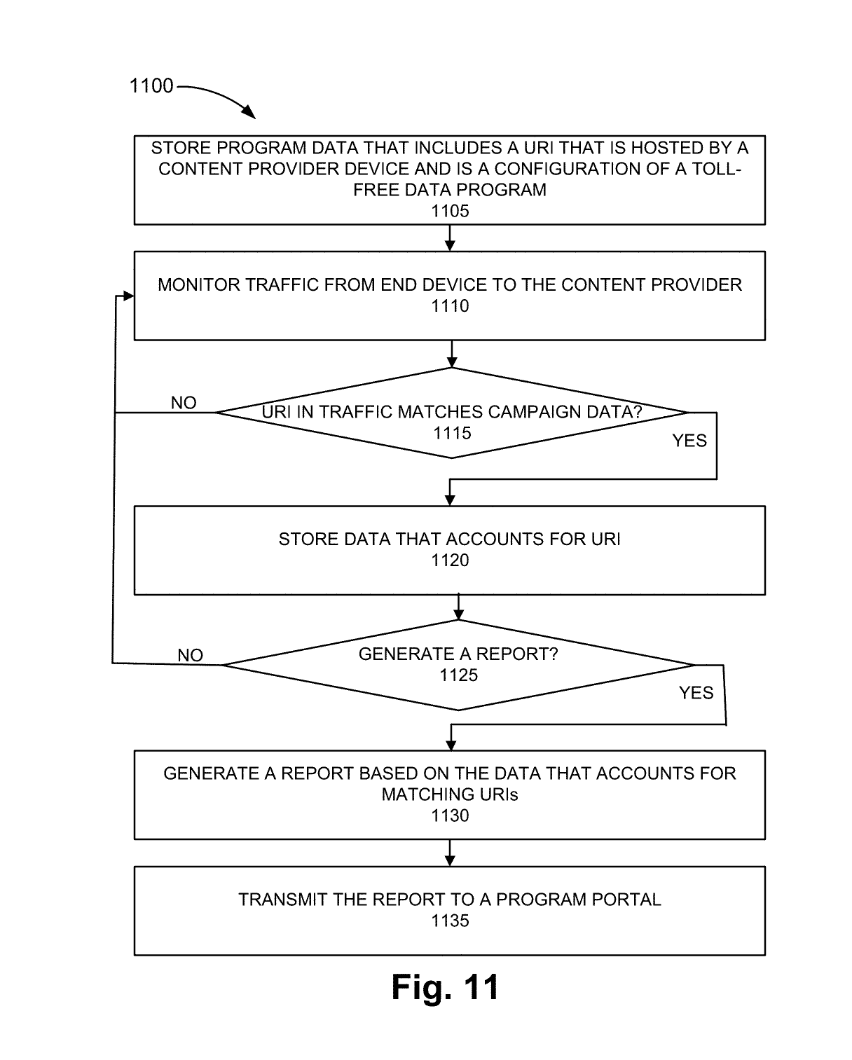

FIG. 11 is a flow diagram illustrating an exemplary process 1100 pertaining to the dynamic toll-free data service. Process 1100 is directed to a process previously described above with respect to FIGS. 9 and 10, as well as elsewhere in this description, in which end device 810 provides a dynamic toll-free data service. For example, processor 510 executes software 520 to perform the steps illustrated in FIG. 11 and described herein.

Referring to FIG. 11, process 1100 may begin, in block 1105, with storing program data that includes a URI that is hosted by a content provider device and is a configuration of a toll-free data program. For example, end device 810 stores program data. The program data includes a URI of content provider device 124 that is used to determine whether a toll-free data service is to be activated. For example, the end user application, which includes toll-free agent 815, may be configured and updated by a content provider device and/or a sponsor device of the toll-free data program. As an example, the program data may be stored as the program data of table 300.

In block 1110, traffic from an end device to the content provider is monitored. For example, end device 810 monitors packets from end device 810 destined to content provider device 124. By way of further example, URI manager 905 inspects TCP header fields of the packets for an HTTP URL.

In block 1115, it is determined whether a URI included in the traffic matches the program data. For example, end device 810 analyzes the packets based on the inspection to determine whether a URL included in the traffic matches a URL included in the program data. By way of further example, URI manager 905 analyzes the URL carried in the packet and determines whether the URL matches any URL included in table 300.

When it is determined that the URI does not match the program data (block 1115—NO), process continues to block 1110. For example, end device 810 continues to monitor the traffic originating from end device 810.

When it is determined that the URI does match the program data (block 1115-YES), data is stored that accounts for the URI (block 1120). For example, end device 810 may count the number of requests that match the URL of a particular toll-free data program. By way of further example, URI manager 905 may use identifier field 305 to aggregate a URL that matches a URL of a particular toll-free data program. URI manager 905 may tally any matching URLs and store data indicating such matching. By way of example, URI manager 905 may store a numerical value representing the number of matching URLs associated with the content provider and/or the toll-free data program.

In block 1125, it is determined whether a report is to be generated. For example, end device 810 determines whether to generate a report in response to storing the data. By way of further example, reporter 910 may determine whether to generate a report based on configurable criteria, such as whether a particular time period has lapsed since the last report has been sent (e.g., for this particular content provider, for this particular toll-free data program, etc.), whether a minimum number of matching URLs has occurred, or any other criteria.

When it is determined that a report is not to be generated (block 1125-NO), process 1100 continues to block 1110. For example, URI manager 905 continues to monitor the traffic. When it is determined that a report is to be generated (block 1125-YES), a report is generated based on the data that accounts for the matching URI (block 1130). For example, end device 810 generates a report that indicates the number of URLs that matched a particular toll-free data program. The report may also include one or multiple identifiers (e.g., of identifier field 305). By way of further example, reporter 910 may generate the report. In block 1135, the report is transmitted to a program portal. For example, end device 810 transmits the report in response to the generation of the report. By way of further example, reporter 910 transmits the report to program portal 122.

Although FIG. 11 illustrates an exemplary process 1100 of the dynamic toll-free data service, according to other embodiments, process 1100 may include additional operations, fewer operations, and/or different operations than those illustrated in FIG. 11 and described herein. For example, subsequent to block 1115—YES, end device 810 may determine whether the toll-free data service is active or not. End device 810 may determine whether the toll-free data service, which is associated with the matching URI, is active or not based on program data. For example, with reference to step 9 of FIG. 10, when end device 810 requests content from content provider device 124 in which a toll-free data service is activated, toll-free agent 815 may determine (e.g., based on data received from content provider device 124) that the toll-free data service of a particular toll-free data program is activated. When the toll-free data service is active, end device 810 may not store data that accounts for the matching URI (i.e., in contrast to block 1120) since the toll-free data service is active and the threshold has been met. Process 1100 may continue to block 1110. Alternatively, end device 810 may store data that accounts for the matching URI and generate a different type of report that can be used by program portal 122 to determine whether to extend or shorten the active toll-free data service, as previously described. However, when the toll-free data service is not active, process 1100 may continue from block 1115-YES to block 1120, as previously described. Program portal 122 may perform a process similar to that of process 700, except that in block 710, program portal 122 receives the report from end device 810.

Turning to another aspect, a content provider may create a program on the program portal in support of a toll-free data service for certain content that may be offered to users of the content provider. While a toll-free data service is a useful tool to attract users, the benefit of the program is limited to users of that particular content provider because unless a user has a certain content provider's application (e.g., a mobile application, a plug-in, etc.) installed on their end device, the user will not know about the certain content that is being sponsored for toll-free data service. Additionally, it is not uncommon for the same content to be offered by different content providers. However, users of one content provider that may have an interest in a particular content may be unaware that another content provider is sponsoring a toll-free data service for the same particular content that is of interest.

According to an exemplary embodiment, a program portal provides a program service. According to an exemplary embodiment, the program portal obtains program data from different content providers. Based on the program data, the program portal generates a contest, on behalf of the content providers, for users to participate and vote. According to an exemplary implementation, the contest allows users to vote on which content they would like to have offered under a toll-free data service. For example, a presentation of the contest may include a listing of different contents offered by different content providers. The program portal posts the contest on a social network. The users may also subscribe to or “follow” one or multiple content providers. The program portal monitors and obtains data indicative of user activity/interest surrounding the contest. The content that receives the highest number of votes is selected as the content to be offered under the toll-free data service. Based on the results of the contest, the program portal generates a toll-free data program and posts the toll-free data program on the social network. For example, the toll-free data program may indicate a particular content that is being offered free of data charges along with other information (e.g., content provider, etc.). The users of the social network site may view the toll-free data program and, in turn may view the content associated with the toll-free data program via the content provider device. Additionally, the program portal updates the toll-free data program during the life of the program.

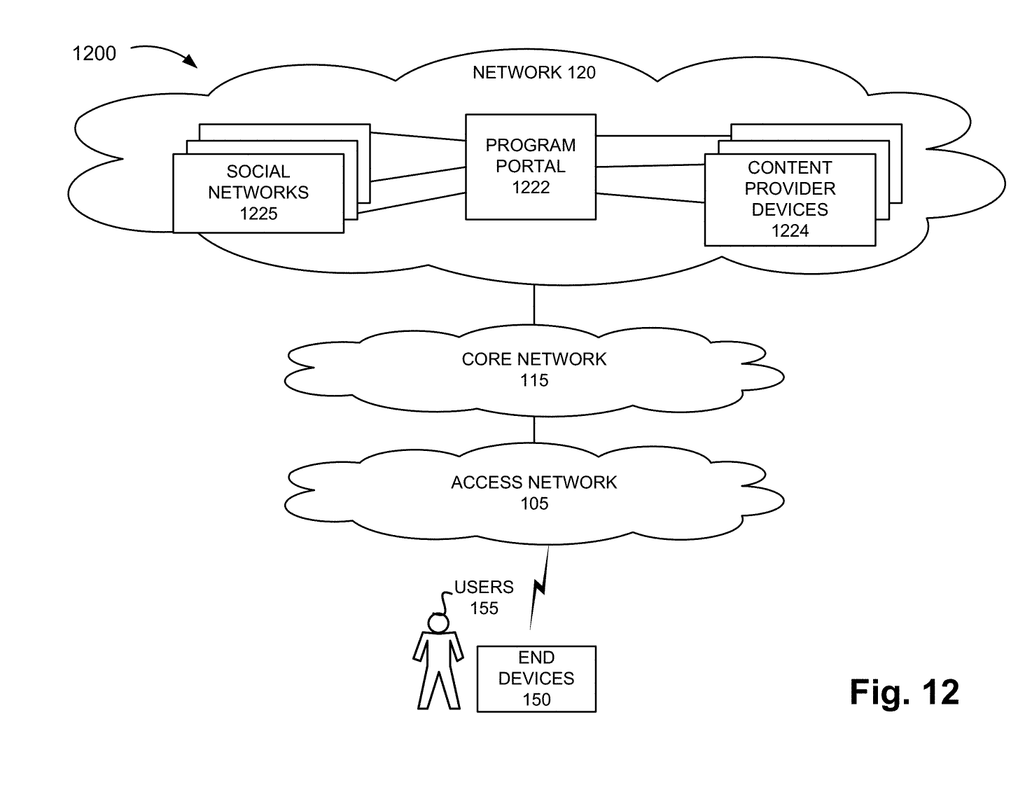

FIG. 12 is a diagram illustrating an exemplary environment in which an exemplary embodiment of a program service may be implemented. As illustrated, environment 1200 includes access network 105, core network 115, and network 120. As illustrated, network 120 includes a program portal 1222, content provider devices 1224, and social networks 1225. Environment 1200 further includes end devices 150 that are operated by users 155. Access network 105, core network 115, network 120, end devices 150, and users 155 have been previously described. The number of network devices, the number of end devices, the number of networks, and the arrangement in environment 1200 are exemplary.

Program portal 1222 includes a network device that provides the program service. Program portal 1222 includes logic that generates, posts, and manages contests based on program data. For example, the program data may be provided by content providers, sponsors of toll-free data programs, and/or subscribers of the program service via content provider devices 1224. Program portal 1222 includes logic that generates, posts, and manages a toll-free data programs based on the result of the contests. Program portal 1222 includes logic that stores program data. The program data includes data indicating parameters of a toll-free data program and a contest. Program portal 1222 may be implemented on a network computer. Program portal 1222 is further described herein.

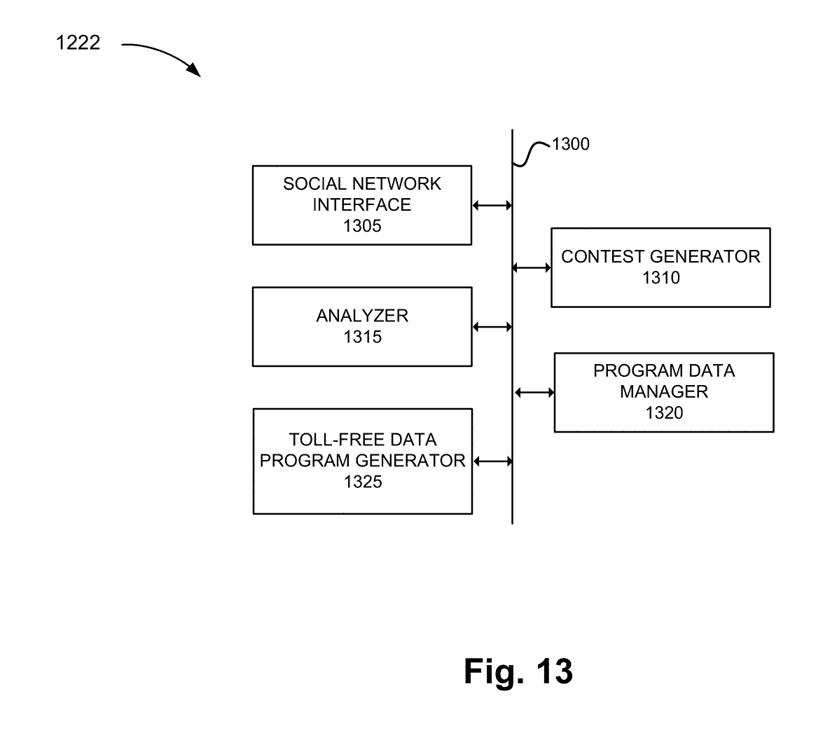

FIG. 13 is a diagram illustrating exemplary elements of an exemplary embodiment of program portal 1222. Referring to FIG. 13, program portal 1222 includes a social network interface 1305, a contest generator 1310, an analyzer 1315, a program data manager 1320, and a toll-free data program generator 1325. According to other exemplary embodiments, program portal 1222 may include additional, fewer, and/or different elements than those illustrated in FIG. 13 and described herein. Additionally, multiple elements may be combined into a single element and/or a single element may be implemented as multiple elements in which a process or a function may be collaboratively performed or multiple processes or functions may be split between them.

Link 1300 provides a communicative link between two or more elements. Link 1300 may be implemented as a hardware link (e.g., a bus, a shared memory space, etc.) or a software link (e.g., inter-process communication (IPC), etc.).

Social network interface 1305 includes logic that communicates with social networks 1225. Social network interface 1305 includes logic to sign-on to social networks 1225. Additionally, for example, social network interface 1305 includes logic that posts contests and toll-free data programs.

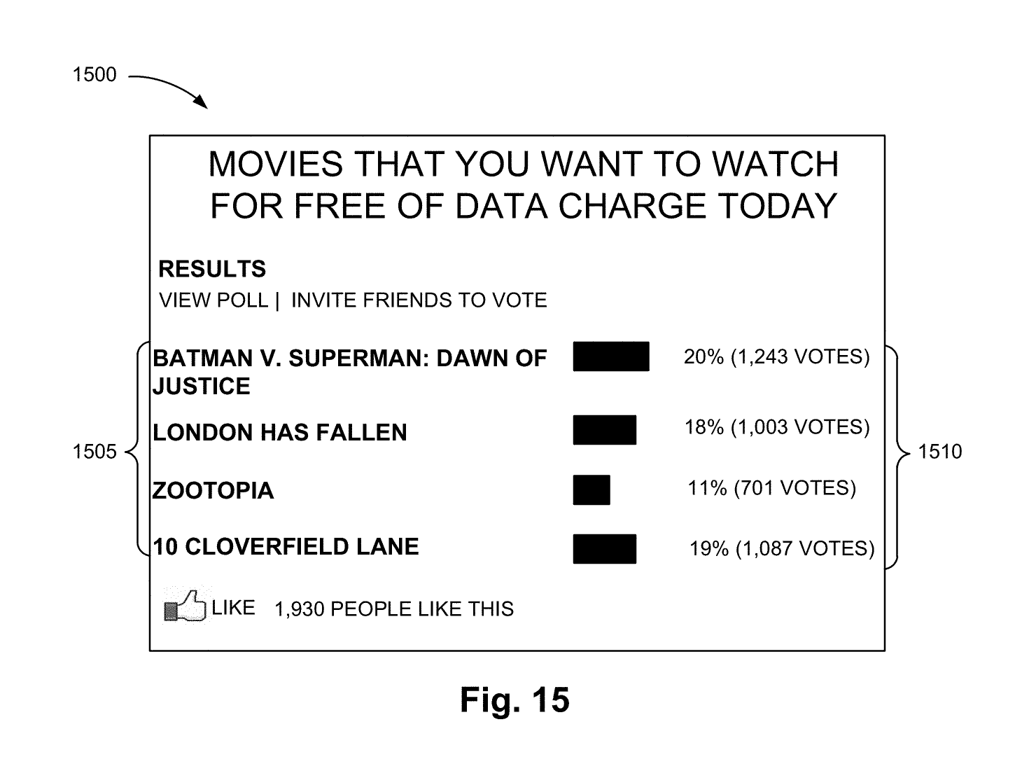

Contest generator 1310 includes logic that generates contests based on program data. For example, contest generator 1310 may select content providers and contents offered by the content providers as a basis to generate a contest. The program data may indicate that the content providers and their respective contents are available for selection and share certain parametric values, such as time period (e.g., date and time) available for selection, type of content (e.g., movie versus television show), and/or other type of configurable criteria. FIG. 15 is a diagram of an exemplary contest 1500. As illustrated, contest 1500 may include a listing of contents 1505 that users 155 may vote on for selection to be offered under a toll-free data service. In this example, contest 1500 also presents a voting result 1510 for each of the contents. According to an exemplary implementation, contest generator 1310 may use a template for generating a contest. Contest 1500 may include logic to provide an interactive environment. Contest generator 1310 may pass a generated contest to social network interface 1305 for posting to social networks 1225. Contest generator 1310 may also pass a social network identifier that identifies the social network 1225 to post on.

Referring back to FIG. 13, analyzer 1315 includes logic that analyzes the statuses of contests and toll-free data programs. For example, analyzer 1315 includes logic that obtains the statuses of contests and toll-free data programs from social networks 1225 based on various communication methods (e.g., polling, push and/or pull methods, etc.). Analyzer 1315 includes logic that determines a status of a contest based on the data obtained. For example, the status of a contest may include expired, completed (e.g., a winner), on-going (e.g., no winner yet), or another type of configurable status (e.g., tied, etc.). Analyzer 1315 includes logic that manages the contest based on the status of the contest. For example, when the status of the contest is expired, analyzer 1315 includes logic that removes the contest from social network 1225 via social network interface 1305. Additionally, for example, when the status of the contest is completed, analyzer 1315 includes logic that removes the contest from social network 1225 and indicates to toll-free data program generator 1325 that the contest is completed. Analyzer 1315 may pass data to toll-free data program generator 1325 that allows toll-free data program generator 1325 to generate a toll-free data program pertaining to a winner of the contest. For example, the data may include a profile identifier that indicates a profile pertaining to toll-free data service program of a particular content provider and a particular content. For example, the program data may include the profile identifier and the profile.

Analyzer 1315 includes logic that manages the toll-free data program. For example, analyzer 1315 includes logic that manages the time period of the toll-free data service, such as when the toll-free data service begins and ends. Additionally, analyzer 1315 includes logic that keeps track of other parameters of the toll-free data service, such as the budgets allocated and the depletion of the budgets during the toll-free data service. As an example, analyzer 1315 may communicate with a billing device that updates the data usage ascribed to the toll-free data service and a budget allocated by a content provider in support of the toll-free data service. Analyzer 1315 includes logic to deactivate a toll-free data service totally or partially (e.g., relative to one content provider among multiple content providers participating in the toll-free data service program) when a budget is depleted. Additionally, analyzer 1315 may cause the time period of a toll-free data service to be extended or shortened based on reporting data, as previously described.

Program data manager 1320 includes logic that stores and updates program data. According to an exemplary embodiment, program data manager 210 includes a DBMS. Program data manager 1320 includes a storage device that stores a database. The database stores program data. For example, the program data may include data pertaining to contests and toll-free data service programs with respect to content providers associated with content provider devices 1224. The database may store the program data in various types of data structures, an example of which is described below.

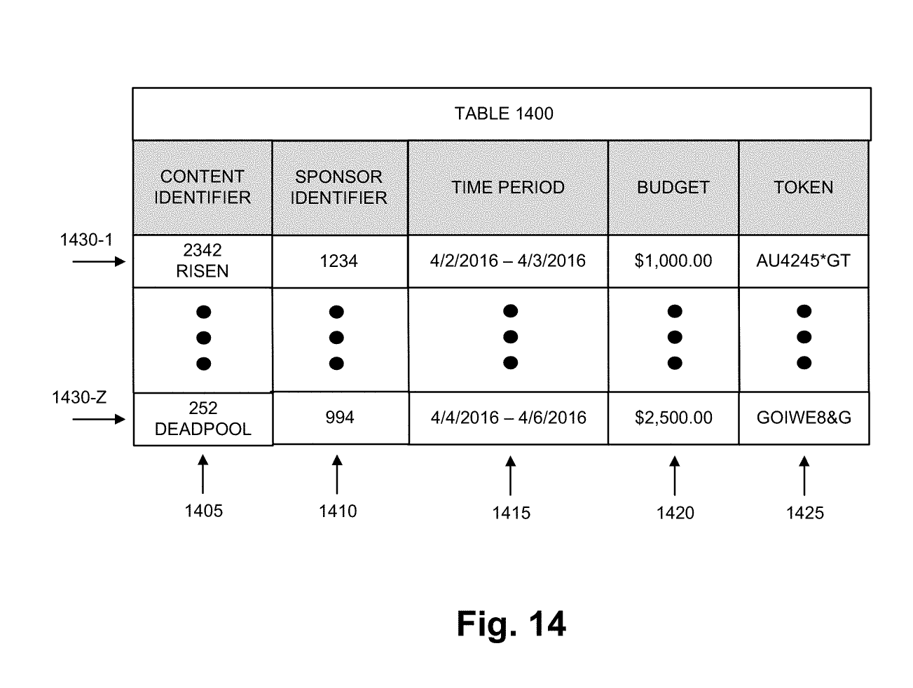

FIG. 14 is a diagram that illustrates exemplary types of program data that may be stored in a table 1400. As illustrated, table 1400 includes a content identifier field 1405, a sponsor identifier field 1410, a time period field 1415, a budget field 1420, and a token field 1425. As further illustrated, table 1400 includes profiles 1430-1 through 1430-Z (also referred to as profiles 1430 and, individually and generically as profile 1430). Each profile 1430 includes a grouping of data fields 1405 through 1425. Each profile 1430 includes at least one instance of program data that is different from another profile 1430.

Content identifier field 1405 stores one or multiple identifiers that identify a content. For example, the identifier may be unique string or a title of the content. Sponsor identifier field 1410 stores a unique identifier that identifies the sponsor of a toll-free data program. Time period field 1415 stores a time period during which a toll-free data service may take place. For example, time period field 1415 may store a date and/or a date and time. Budget field 1420 stores data that indicates a budget associated with the toll-free data service. For example, budget field 1420 may store a monetary value, a data usage value (e.g., in terms of MBs, GBs, or other data usage metric), or other parameter. Token field 1425 stores a token. The token may be used to validate or authenticate content provider device 1224 and/or social network 1225.

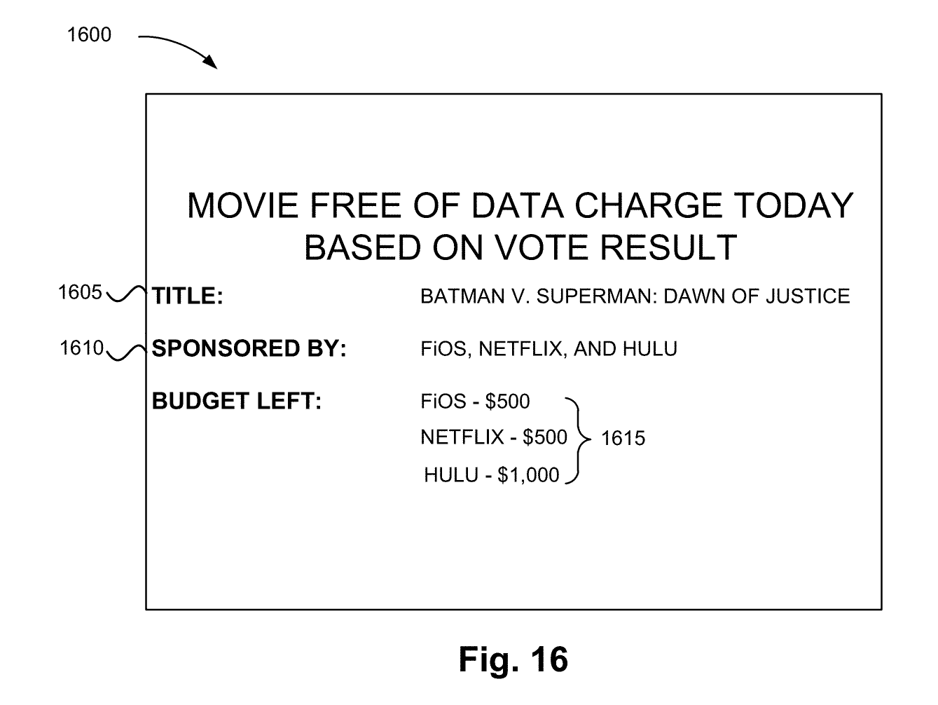

Referring back to FIG. 13, toll-free data program generator 1325 includes logic that generates a toll-free data program based on the program data and/or a result of a contest. For example, toll-free data program generator 1325 may select a content provider and a content to generate a toll-free data program. FIG. 16 is a diagram illustrating a diagram of an exemplary program 1600 for a toll-free data service program. According to this example, program 1600 includes a content identifier 1605, a sponsor identifier 1610, and budget data 1615. Budget data 1615 may be updated to reflect the current budget associated with a sponsor in correspondence to the data usage stemming from users 155 streaming or downloading of the content. Toll-free data program generator 1325 may pass the generated program 1600 to social network interface 1305 for posting to social networks 1225. Toll-free data program generator 1325 may also pass a social network identifier that identifies the social network to post on.

Referring back to FIG. 13, content provider devices 1224 include network devices and/or end devices managed by content providers and are used to interface with the service provider of the program service. For example, content provider devices 1224 may provide program portal 1222 with information that allows content providers to subscribe to the program service. Additionally, content provider devices 124 may provide program data in support of toll-free data programs offered by the content providers. Content provider devices 1224 may also receive billing records or charges that accrue during the toll-free data service.

Social networks 1225 include network devices that provide social network services. For example, each social network 1225 may be a social network website on the Internet. Users 155 (or a portion thereof) may belong to at least one of the social networks 1225. Examples of a social network 1225 may include Facebook, Twitter, and so forth. According to an exemplary implementation, each social network 1225 includes a feed service or follow-service to which users 155 can subscribe and receive information pertaining to a content provider, an ISP, or an entity that provides a toll-free data service pertaining to content. In this way, users 155 of social network 1225 may be able to participate in the contest and also become aware of the toll-free data program associated with one or multiple content providers, which users 155 may or may not subscribe to their content provider service.

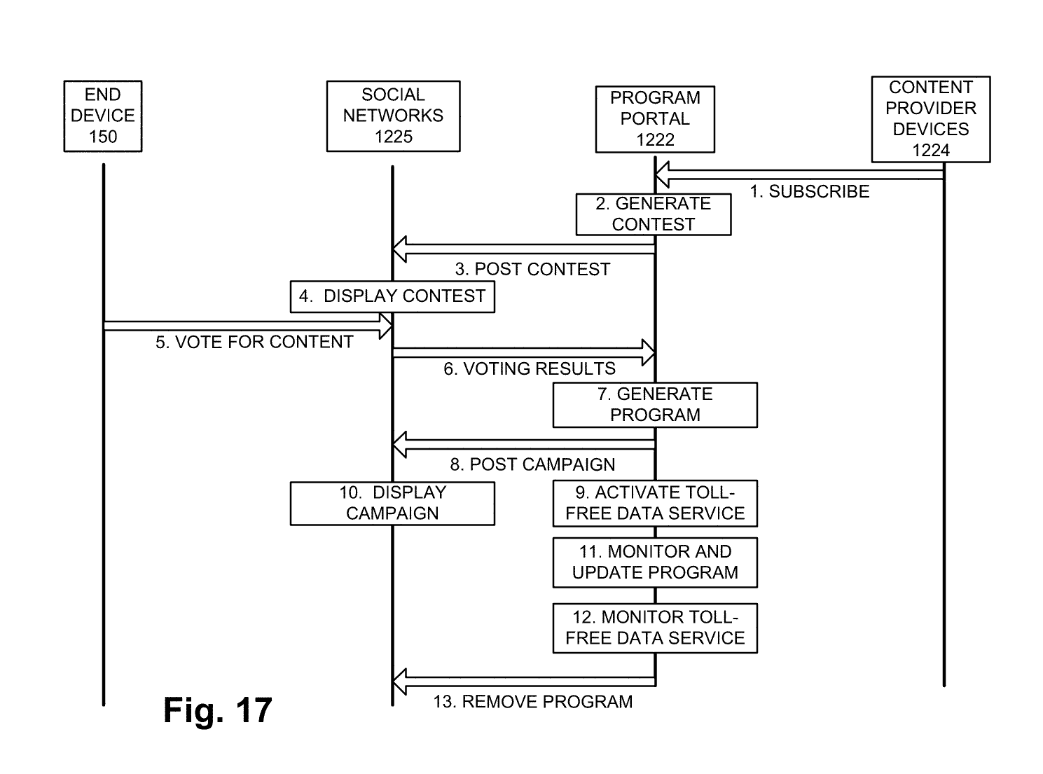

FIG. 17 is a diagram illustrating an exemplary process of the program service performed in environment 1200. As illustrated in FIG. 17, in step 1, content providers subscribe to the program service via content provider devices 1224 and program portal 1222. For example, content provider devices 1224 may provide program data that indicates parameters pertaining to contests and toll-free data services. In step 2, in response to the subscriptions and program data, program portal 1222 generates a contest. In step 3, program portal 1222 posts the generated content at social networks 1225 in response to the generation of the contest. In step 4, social networks 1225 present, display, or make available the contest in response to the posting. In step 5, users 155 may vote on the posted contest via end devices 150. In step 6, program portal 1222 monitors and analyzes participation in the contest by users 155. Program portal 1222 may obtain results of the contest. According to this example, program portal 1222 determines a winner of the contest. In step 7, program portal generates a program based on the results of the contest. In step 8, program portal 1222 posts the program on social networks 1225 in response to the generation of the program. In step 9, program portal 1222 activates the toll-free data service in response to the generation of the program. In step 10, social networks 1225 present, display, or make available the program in response to the posting.

In step 11, program portal 1222 monitors and updates the program posted on the social networks during the toll-free data service time period. For example, as previously described, program portal 1222 may update the program posted at social networks 1225 with respect to budget left. For example, when the budget left (e.g., budget data 1615) indicates a monetary value, the monetary value may be decremented. Alternatively, when the budget left indicates a data usage metric (e.g., GBs), the data usage metric left may be decremented. Additionally, for example, a sponsor may be removed from the program (e.g., as indicated as sponsor identifier 1610) when the budget has completely depleted for that sponsor. In this way, users 155 may be directed to content providers that still have a remaining budget that can support the toll-free data service associated with the sponsored content. In step 12, program portal 1222 monitors the toll-free data service. For example, program portal 1222 may monitor the time period during which the toll-free data service is to be active based on the program data. Additionally, program portal 1222 may extend or shorten the toll-free data service, as previously described. When program portal 1222 determines that the toll-free data service is to end, in step 13, program portal 1222 removes the posting of the program and the toll-free data service is terminated.

Although FIG. 17 illustrates an exemplary program service process, according to other exemplary embodiments, additional and/or different operations may be performed.

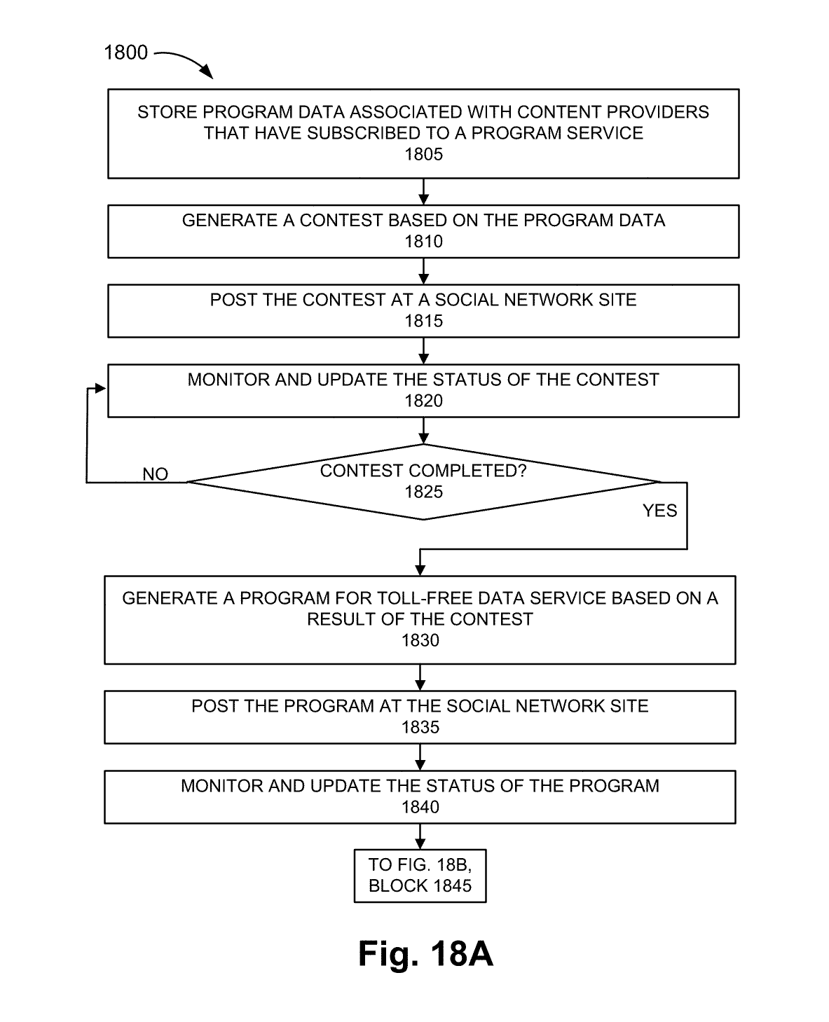

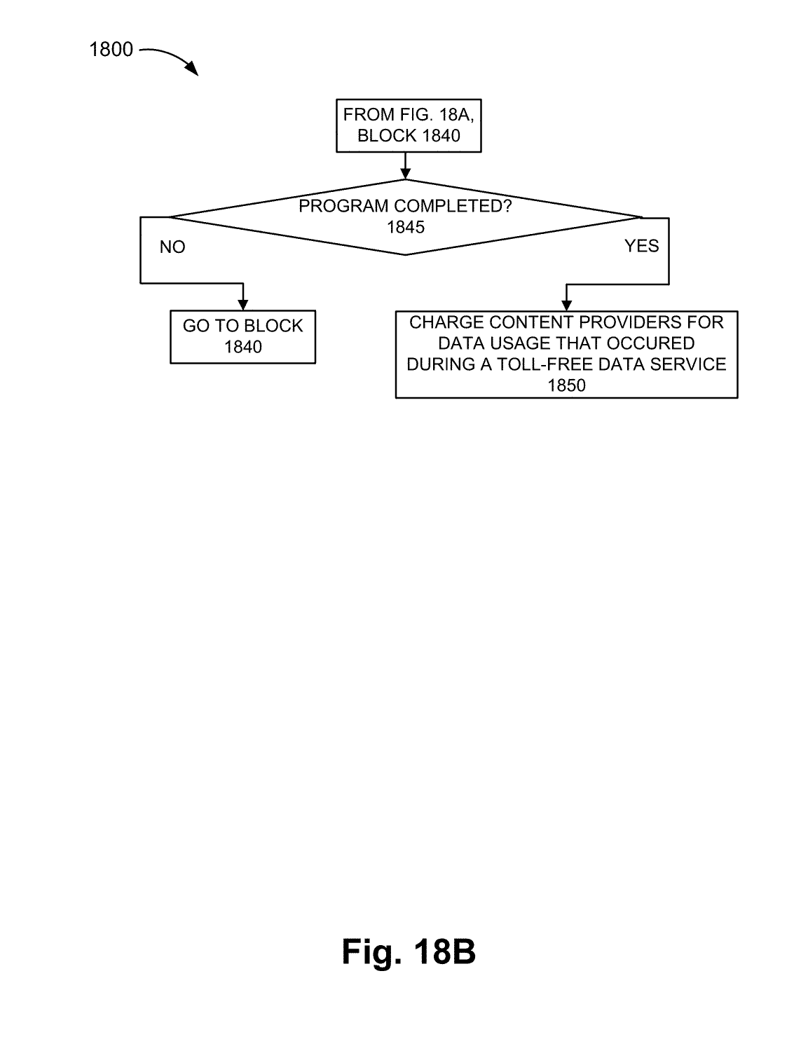

FIGS. 18A and 18B are flow diagrams illustrating an exemplary process 1800 pertaining to the program service. Process 1800 is directed to a process previously described above with respect to FIGS. 13-17, as well as elsewhere in this description, in which program portal 1222 provides a program service. For example, processor 510 executes software 520 to perform the steps illustrated in FIG. 18 and described herein.

Referring to FIG. 18A, process 1800 may begin, in block 1805, with storing program data associated with content providers that have subscribed to a program service. For example, program portal 1222 stores program data to be used to generate contests and programs. By way of further example, program portal 1222 stores program data, such as that described in relation to table 1400 and/or other program data described herein. In block 1810, a contest is generated based on the program data. For example, program portal 1222 generates a contest based on the program data. For example, the contest may be implemented as contest 1500 previously described. Contest 1500 may include logic to provide an interactive environment, such as to receive user input, display a result of the user input, etc. In block 1815, the contest is posted at a social network site in response to the generating. For example, program portal 1222 posts the contest on social networks 1225.

In block 1820, the status of the contest is monitored and updated. For example, program portal 1222 monitors the progress of the contest based on participation and user activity from users 155 in relation to the posted contest. Program portal 1222 updates the data presented to users 155 (e.g., number of votes) during the progress of the contest.

In block 1825, it is determined whether the contest is completed. For example, program portal 1222 analyzes the progress of the contest and determines whether a winner of the contest has occurred. For example, program portal 1222 whether a particular contest has received more votes from users 155 than other content. When it is determined that the contest is not completed (block 1825-NO), process 1800 may continue to block 1820. When it is determined that the contest is completed (block 1825-YES), a program is generated based on the result of the contest (block 1830). For example, program portal 1222 generates a program for a toll-free data service based on the result of the contest. For example, program portal 1222 selects a content provider and a content that is being offered under a toll-free data service. For example, the program may be implemented as program 1600 previously described.

In block 1835, the program is posted at the social network in response to the generating. For example, program portal 1222 posts the program on social networks 1225.

In block 1840, the status of the program is monitored and updated. For example, program portal 1222 monitors the progress of the program based on data usage ascribed to the toll-free data service. Program portal 1222 updates the data presented to users 155 (e.g., budget left) during the progress of the program.

Referring to FIG. 18B, in block 1845, it is determined whether the program is completed. For example, program portal 1222 determines when the program is completed based on a time period assigned to the program. When it is determined that the program is not completed (block 1845-NO), process 1800 may continue to block 1840 in which the program is monitored. When it is determined that the program is completed (block 1845-YES), the content providers are charged for data usage that accrued during a toll-free data service (block 1850). For example, program portal 1222 may transmit billing data to the content provider that sponsored the toll-free data service.

Although FIG. 18 illustrates an exemplary process 1800 of the program service, according to other embodiments, process 1800 may include additional operations, fewer operations, and/or different operations than those illustrated in FIG. 18 and described herein.

The foregoing description of embodiments provides illustration, but is not intended to be exhaustive or to limit the embodiments to the precise form disclosed. Accordingly, modifications to the embodiments described herein may be possible

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items.

In addition, while series of blocks have been described with regard to the processes illustrated in FIGS. 6, 7, 11, 18A, and 18B, the order of the blocks may be modified according to other embodiments. Further, non-dependent blocks may be performed in parallel. Additionally, other processes described in this description may be modified and/or non-dependent operations may be performed in parallel.

The embodiments described herein may be implemented in many different forms of software executed by hardware. For example, a process or a function may be implemented as “logic” or as a “component.” The logic or the component may include, for example, hardware (e.g., processor 510, etc.), or a combination of hardware and software (e.g., software 520). The embodiments have been described without reference to the specific software code since the software code can be designed to implement the embodiments based on the description herein and commercially available software design environments/languages.

In the preceding specification, various embodiments have been described with reference to the accompanying drawings. However, various modifications and changes may be made thereto, and additional embodiments may be implemented, without departing from the broader scope of the invention as set forth in the claims that follow. The specification and drawings are accordingly to be regarded as illustrative rather than restrictive.

In the specification and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The word “exemplary” is used herein to mean “serving as an example.” Any embodiment or implementation described as “exemplary” is not necessarily to be construed as preferred or advantageous over other embodiments or implementations.

Additionally, embodiments described herein may be implemented as a non-transitory storage medium that stores data and/or information, such as instructions, program code, data structures, program modules, an application, etc. The program code, instructions, application, etc., is readable and executable by a processor (e.g., processor 510) of a computational device. A non-transitory storage medium includes one or more of the storage mediums described in relation to memory/storage 515.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction described in the present application should be construed as critical or essential to the embodiments described herein unless explicitly described as such.

What is claimed is:

1. A method comprising:
storing, by a device, program data that includes a first uniform resource identifier that is hosted by a content provider device;
monitoring, by the device, first packets transmitted from end devices to the content provider device;
determining, by the device, whether the first packets include the first uniform resource identifier in response to the monitoring;
storing, by the device, a first value that indicates a number of times the first uniform resource identifier was included in the first packets in response to determining that the first uniform resource identifier is included in the first packets;
generating, by the device, a first report that includes the first value based on the storing of the first value;
transmitting, by the device, the first report to an other device in response to the generating;
receiving, by the device and from the other device, a first request, in response to the first report, that indicates to activate a toll-free data service for a content hosted by the content provider device;
updating, by the device, the program data in response to receiving the first request, wherein the program data is updated to indicate that the toll-free data service is activated; and
providing, by the device, the toll-free data service based on the updating.

2. The method of claim 1, further comprising:
analyzing, by the other device, the first report;
determining, by the other device, whether the toll-free data service is to be activated based on the analyzing; and
generating, by the other device, the request in response to determining that the toll-free data service is to be activated.

3. The method of claim 2, further comprising:
storing a first threshold value that indicates a threshold number of times the first uniform resource identifier is to be requested by users of the end devices before the toll-free data service is activated, and wherein the analyzing comprises:
comparing the first threshold value to the first value, and wherein determining whether the toll-free data service is to be activated based on the analyzing comprises:
determining whether the first value satisfies the first threshold value based on the comparing.

4. The method of claim 1, wherein the first uniform resource identifier is different from a second uniform resource identifier of the content.

5. The method of claim 4, wherein the providing comprises:
monitoring, by the device, second packets transmitted from end devices to the content provider device during the activation of the toll-free data service;
determining, by the device, whether the second packets include the second uniform resource identifier in response to the monitoring of the second packets;
storing, by the device, a second value that indicates a number of times the second uniform resource identifier was included in the second packets in response to determining that the second uniform resource identifier is included in the second packets;
generating, by the device, a second report that includes the second value based on the storing;
transmitting, by the device, the second report to the other device in response to the generating of the second report; and
extending or shortening a duration of the toll-free data service based on the second report.

6. The method of claim 4, wherein the providing comprises:
monitoring, by the device, second packets transmitted from end devices to the content provider during during the activation of the toll-free data service;
determining, by the device, whether the second packets include the second uniform resource identifier in response to the monitoring of the second packets; and
generating, by the device, data usage records in response to determining that the second packets include the second uniform resource identifier.

7. The method of claim 1, wherein during the activation of the toll-free data service, the method further comprises:
monitoring, by the device, second packets transmitted from end devices to the content provider device;
determining, by the device, whether the second packets include the first uniform resource identifier in response to the monitoring of the second packets; and
omitting to generate, by the device, a report that indicates a number of times the first uniform resource identifier was included in the second packets based on the updated program data.

8. The method of claim 1, wherein the first uniform resource identifier is different from a second uniform resource identifier of the content.

9. A system comprising:
a first network device comprising:
a first communication interface;
a first memory, wherein the first memory stores first instructions; and
a first processor, wherein the first processor executes the first instructions to:
store program data that includes a first uniform resource identifier that is hosted by a content provider device;
monitor first packets transmitted from end devices to the content provider device;
determine whether the first packets include the uniform resource identifier based on the first packets that have been monitored;
store a first value that indicates a number of times the uniform resource identifier was included in the first packets in response to a determination that the uniform resource identifier is included in the first packets;
generate a first report that includes the first value based on the stored first value;
transmit, via the first communication interface, the first report to a second network device in response to the generation of the first report;
receive, via the first communication interface and from the second network device, a request, in response to the first report, that indicates to activate a toll-free data service for a content hosted by the content provider device;
update the program data in response to the receipt of the request, wherein the program data is updated to indicate that the toll-free data service is activated; and
provide the toll-free data service based on the updated program that indicates that the toll-free data service is activated.

10. The system of claim 9, further comprising:
the second network device comprising:
a second communication interface;
a second memory, wherein the second memory stores second instructions; and
a second processor, wherein the second processor executes the second instructions to:
receive, via the second communication interface and from the first network device, the first report;
analyze the first report in response to the receipt of the first report;
determine whether the toll-free data service is to be activated based on the analysis of the first report;
generate the request in response to a determination that the toll-free data service is to be activated; and
transmit, via the second communication interface and to the first network device, the request in response to the generation of the request.

11. The system of claim 10, wherein the second processor further executes the second instructions to:
store a first threshold value that indicates a threshold number of times the first uniform resource identifier is to be requested by users of the end devices before the toll-free data service is activated, and wherein when analyzing, the second processor further executes the second instructions to:
compare the first threshold value to the first value, and wherein when determining whether the toll-free data service is to be activated based on the analysis, the second processor further executes the second instructions to:
determine whether the first value satisfies the first threshold value based on the comparison.

12. The system of claim 9, wherein the first uniform resource identifier is different from a second uniform resource identifier of the content.

13. The system of claim 12, wherein when providing, the first processor further executes the first instructions to:
monitor second packets transmitted from end devices to the content provider device during the activation of the toll-free data service;
determine whether the second packets include the second uniform resource identifier based on the second packets that have been monitored;
store a second value that indicates a number of times the second uniform resource identifier was included in the second packets in response to a determination that the second uniform resource identifier is included in the second packets;
generate a second report that includes the stored second value;
transmit, via the first communication interface, the second report to the second network device in response to the generation of the second report; and
extend or shorten a duration of the toll-free data service based on the second report.

14. The device of claim 12, wherein when providing, the first processor further executes the first instructions to:
monitor second packets transmitted from end devices to the content provider device during the activation of the toll-free data service;
determine whether the second packets include the second uniform resource identifier based on the second packets that have been monitored;
generate data usage records in response to a determination that the second packets include the second uniform resource identifier; and
transmit, via the first communication interface, the data usage records to a billing system.

15. The system of claim 9, wherein when providing, the first processor further executes the first instructions to:
monitor second packets transmitted from end devices to the content provider device;
determine whether the second packets include the first uniform resource identifier based on the second packets that have been monitored; and
omit to generate a report that indicates a number of times the first uniform resource identifier was included in the second packets based on the updated program data that indicates that the toll-free data service is activated.

16. A non-transitory, computer-readable storage medium storing instructions executable by a processor of a computational device, which when executed cause the computational device to:
store program data that includes a first uniform resource identifier that is hosted by a content provider device;
monitor first packets transmitted from end devices to the content provider device;
determine whether the first packets include the first uniform resource identifier based on the first packets that have been monitored;
store a first value that indicates a number of times the first uniform resource identifier was included in the first packets in response to a determination that the first uniform resource identifier is included in the first packets;
generate a first report that includes the first value based on the stored first value;
transmit the first report to a network device in response to the generation of the first report;
receive from the network device, a request, in response to the first report, that indicates to activate a toll-free data service for a content hosted by the content provider device;
update the program data in response to the receipt of the request, wherein the program data is updated to indicate that the toll-free data service is activated; and
provide the toll-free data service based on the updated program that indicates that the toll-free data service is activated.

17. The non-transitory, computer-readable storage medium of claim 16, wherein the first uniform resource identifier is different from a second uniform resource identifier of the content.

18. The non-transitory, computer-readable storage medium of claim 17, further storing instructions to:
monitor second packets transmitted from end devices to the content provider device during the activation of the toll-free data service;
determine whether the second packets include the second uniform resource identifier based on the second packets that have been monitored;
store a second value that indicates a number of times the second uniform resource identifier was included in the second packets in response to a determination that the second uniform resource identifier is included in the second packets;
generate a second report that includes the stored second value;
transmit the second report to the network device in response to the generation of the second report; and
extend or shorten a duration of the toll-free data service based on the second report.

19. The non-transitory, computer-readable storage medium of claim 17, further storing instructions to:
monitor second packets transmitted from end devices to the content provider device during the activation of the toll-free data service;
determine whether the second packets include the second uniform resource identifier based on the second packets that have been monitored;
generate data usage records in response to a determination that the second packets include the second uniform resource identifier; and
transmit the data usage records to a billing system.

20. The non-transitory, computer-readable storage medium of claim 16, further storing instructions to:
monitor second packets transmitted from end devices to the content provider device during the activation of the toll-free data service;
determine whether the second packets include the first uniform resource identifier based on the second packets that have been monitored; and
omit to generate a report that indicates a number of times the first uniform resource identifier was included in the second packets based on the updated program data that indicates that the toll-free data service is activated.
